(19) United States
(12) Patent Application Publication
(10) Pub. No.: US 2017/0063958 A1
(43) Pub. Date: Mar. 2, 2017

(54) SYSTEMS AND METHODS FOR CONSTRAINING A BITSTREAM

(71) Applicant: Sharp Kabushiki Kaisha, Sakai-shi, Osaka (JP)

(72) Inventor: Sachin G. DESHPANDE, Camas, WA (US)

(21) Appl. No.: 15/118,534

(22) PCT Filed: Mar. 16, 2015
(86) PCT No.: PCT/JP2015/001447

§ 371 Date: Aug. 12, 2016

Related U.S. Application Data
(63) Continuation of application No. 14/214,628, filed on Mar. 14, 2014.
(60) Provisional application No. 61/955,104, filed on Mar. 18, 2014.

(51) Int. Cl. H04L 29/06; H04N 19/70

(52) U.S. Cl. CPC H04L 65/602; H04L 65/80; H04N 19/70

(57) ABSTRACT

A method for constraining a bitstream by an electronic device is described. The method includes obtaining a message structure. The message structure includes a parameter structure corresponding to a bitstream partition. The method also includes obtaining a parameter structure index referring to the parameter structure. The method further includes determining whether the parameter structure index is within a parameter structure index valid range. The method additionally includes generating a first indication if the parameter structure index is not within the parameter structure index valid range.

### TECHNICAL FIELD

The present disclosure relates generally to electronic devices. More specifically, the present disclosure relates to systems and methods for constraining a bitstream.

### BACKGROUND ART

Electronic devices have become smaller and more powerful in order to meet consumer needs and to improve portability and convenience. Consumers have become dependent upon electronic devices and have come to expect increased functionality. Some examples of electronic devices include desktop computers, laptop computers, cellular phones, smart phones, media players, integrated circuits, etc.

Some electronic devices are used for processing and displaying digital media. For example, portable electronic devices now allow for digital media to be consumed at almost any location where a consumer may be. Furthermore, some electronic devices may provide download or streaming of digital media content for the use and enjoyment of a consumer.

### SUMMARY OF INVENTION

### Technical Problem

The increasing popularity of digital media has presented several problems. For example, efficiently representing high-quality digital media for storage, transmittal and playback presents several challenges. As can be observed from this discussion, systems and methods that represent digital media more efficiently may be beneficial.

### Solution to Problem

According to the present invention, there is a provided a method for constraining a bitstream by an electronic device, comprising:obtaining a message structure, wherein the message structure comprises a parameter structure corresponding to a bitstream partition;obtaining a parameter structure index referring to the parameter structure;determining whether the parameter structure index is within a parameter structure index valid range; and generating a first indication if the parameter structure index is not within the parameter structure index valid range.

According to the present invention, there is a provided An electronic device for constraining a bitstream, comprising:a processor;memory in electronic communication with the processor, wherein instructions stored in the memory are executable to: obtain a message structure, wherein the message structure comprises a parameter structure corresponding to a bitstream partition; obtain a parameter structure index referring to the parameter structure; determine whether the parameter structure index is within a parameter structure index valid range; and generate a first indication if the parameter structure index is not within the parameter structure index valid range.

According to the present invention, there is a provided a non-transitory, tangible computer-readable medium for constraining a bitstream, comprising executable instructions for: obtaining a message structure, wherein the message structure comprises a parameter structure corresponding to a bitstream partition; obtaining a parameter structure index referring to the parameter structure; determining whether the parameter structure index is within a parameter structure index valid range; and generating a first indication if the parameter structure index is not within the parameter structure index valid range.

### BRIEF DESCRIPTION OF DRAWINGS

FIG. 1 is a block diagram illustrating an example of one or more electronic devices in which systems and methods for constraining a bitstream may be implemented;

FIG. 2 is a flow diagram illustrating one configuration of a method for constraining a bitstream;

FIG. 3 is a block diagram illustrating one example of a message structure in accordance with the systems and methods disclosed herein;

FIG. 4 is a block diagram illustrating a more specific example of a message structure in accordance with the systems and methods disclosed herein;

FIG. 5 is a block diagram illustrating another more specific example of a message structure in accordance with the systems and methods disclosed herein;

FIG. 6 is a flow diagram illustrating another configuration of a method for constraining a bitstream;

FIG. 7 is a block diagram illustrating examples of a bitstream constraining module;

FIG. 8 is a block diagram illustrating one configuration of an encoder on an electronic device;

FIG. 9 is a block diagram illustrating one configuration of a decoder on an electronic device;

FIG. 10 illustrates various components that may be utilized in an electronic device;

FIG. 11 is a block diagram illustrating one configuration of an electronic device in which systems and methods for constraining a bitstream may be implemented; and

FIG. 12 is a block diagram illustrating another configuration of an electronic device in which systems and methods for constraining a bitstream may be implemented.

### DESCRIPTION OF EMBODIMENTS

A method for constraining a bitstream by an electronic device is described. The method includes obtaining a message structure. The message structure includes a parameter structure corresponding to a bitstream partition. The method also includes obtaining a parameter structure index referring to the parameter structure. The method further includes determining whether the parameter structure index is within a parameter structure index valid range. The method additionally includes generating a first indication if the parameter structure index is not within the parameter structure index valid range. The message structure may be a Video Parameter Set (VPS) Video Usability Information (VUI) message structure or a bitstream partition Hypothetical Reference Decoder (HRD) parameters Supplemental Enhancement Information (SEI) message structure. The parameter structure index may be coded using a fixed length coding scheme.

The message structure may include a delivery schedule index and a sub-layer Hypothetical Reference Decoder (HRD) parameter structure. The method may also include identifying a delivery schedule valid range from the sub-layer HRD parameter structure. The method may further include determining whether the delivery schedule index is within the delivery schedule valid range. The method may additionally include generating a second indication if the delivery schedule index is not within the delivery schedule valid range.

If only one bitstream partition is signaled for a layer set in the message structure, the bitstream partition may not exactly match the layer set. If only one bitstream partition is signaled for a layer set in the message structure, the bitstream partition may be allowed to match the layer set if no parameters in the message structure are signaled for the layer set or if parameters specific to the bitstream partition match any parameters signaled in a Video Parameter Set (VPS) for the layer set.

Any layer in a layer set may not be included in more than one bitstream partition. Each bitstream partition of a layer set may be distinct from any other bitstream partition of the layer set.

An electronic device for constraining a bitstream is also described. The electronic device includes a processor. The electronic device also includes memory in electronic communication with the processor. Instructions stored in the memory are executable to obtain a message structure. The message structure includes a parameter structure corresponding to a bitstream partition. The instructions are further executable to obtain a parameter structure index referring to the parameter structure. The instructions are additionally executable to determine whether the parameter structure index is within a parameter structure index valid range. The instructions are also executable to generate a first indication if the parameter structure index is not within the parameter structure index valid range.

A non-transitory, tangible computer-readable medium for constraining a bitstream is also described. The computer-readable medium includes executable instructions for obtaining a message structure. The message structure includes a parameter structure corresponding to a bitstream partition. The computer-readable medium also includes executable instructions for obtaining a parameter structure index referring to the parameter structure. The computer-readable medium further includes executable instructions for determining whether the parameter structure index is within a parameter structure index valid range. The computer-readable medium additionally includes executable instructions for generating a first indication if the parameter structure index is not within the parameter structure index valid range.

The systems and methods disclosed herein provide approaches for signaling and constraints for bitstream partition buffer parameters for Scalable High-Efficiency Video Coding (SHVC) and Multi-view (MV) High Efficiency Video Coding (HEVC) (MV-HEVC) standards. The HEVC standard is described in the document “High efficiency video coding (HEVC) text specification draft 10,” JCTVC-L1003. The text draft for MV-HEVC is given in the document “MV-HEVC Draft Text 7,” JCT3V-G1004. The text draft for SHVC is given in the document “High Efficiency Video Coding (HEVC) Scalable Extension Draft 5,” JCTVC-P1008.

In JCTVC-P1008 and JCT3V-G1004, bitstream partitioning is defined. A bitstream partition is a sequence of bits, in the form of a Network Abstraction Layer (NAL) unit stream or a byte stream that is a subset of a bitstream according to a partitioning. A base bitstream partition is a bitstream partition that is also a conforming bitstream itself. A bitstream specific coded picture buffer (CPB) operation and bitstream partition specific CPB operation is defined in Annex C. For each bitstream conformance test, the operation of the CPB and the bitstream partition buffer (BPB) is specified in C.2. Bitstream partition specific Hypothetical Reference Decoder (HRD) parameters can be signaled in video parameter set (VPS) video usability information (VUI) (e.g., in vps_vui_bsp_hrd_parameters( )) syntax structure and/or in a bitstream partition HRD parameters supplemental enhancement information (SEI) message (e.g., in bsp_hrd( )).

Some approaches for signaling and various constraints for bitstream partition buffer HRD parameters for SHVC and Multi-view HEVC are given as follows. A bitstream constraint may be utilized that ensures that when HRD parameters are signaled for a bitstream partition in a VPS VUI message, the signaled index of an hrd_parameters( ) structure for a bitstream partition is within a valid range of hrd_parameters( ) structures signaled in the vps_vui_bsp_hrd_parameters( ) syntax structure. Additionally or alternatively, a bitstream constraint may be utilized that ensures that when HRD parameters are signaled for a bitstream partition in a bitstream partition HRD parameters SEI message structure, the signaled index of an hrd_parameters( ) structure for a bitstream partition is within a valid range of hrd_parameters( ) structures signaled in the bsp_hrd( ) SEI message structure.

A bitstream constraint may be utilized that ensures that when HRD parameters are signaled for a bitstream partition in a VPS VUI message structure, the signaled index of a delivery schedule within an hrd_parameters( ) structure is within a valid range of delivery schedules signaled in the sub_layer_hrd_parameters structure in that hrd_parameters( ) structure. Additionally or alternatively, a bitstream constraint may be utilized that ensures that when HRD parameters are signaled for a bitstream partition in a bitstream partition HRD parameters SEI message structure, the signaled index of a delivery schedule within an hrd_parameters( ) structure is within a valid range of delivery schedules signaled in the sub_layer_hrd_parameters structure in that hrd_parameters( ) structure.

A bitstream constraint may be utilized that ensures that when only one bitstream partition is signaled for a layer set in a vps_vui_bsp_hrd_parameters( ) structure, the bitstream partition does not exactly match the corresponding layer set. Additionally or alternatively, a bitstream constraint may be utilized that ensures that when only one bitstream partition is signaled for a layer set in a bitstream partition HRD parameters SEI message structure, the bitstream partition does not exactly match the corresponding layer set.

Since there is a limited range of values that can be assigned to a bsp_comb_hrd_idx[h][i][j] syntax element in the VPS VUI HRD parameters (e.g., vps_vui_bsp_hrd_parameters( ) syntax and that it is unlikely that some index values are taken more often than others, u(v) coding may be utilized for this syntax element instead of the ue(v) coding used in a known approach. Additionally or alternatively, since there is a limited range of values that can be assigned to an sei_bsp_comb_hrd_idx[i][j] syntax element in bitstream partition HRD parameters SEI message syntax and that it is unlikely that some index values are taken more often than others, u(v) coding may be utilized for this syntax element instead of the ue(v) coding used in a known approach.

In a known approach for signaling bitstream partition specific HRD parameters in a vps_vui_bsp_hrd_parameters( ) structure, it is possible to include a layer in a layer set in multiple bitstream partitions. However, there may not be any benefit of doing partitioning in this manner. The systems and methods disclosed herein provide options to prevent including a layer in a layer set in multiple bitstream partitions. Additionally or alternatively, in a known approach for signaling bitstream partition specific HRD parameters in a bitstream partition HRD parameters SEI message structure, it is possible to include a layer in a layer set in multiple bitstream partitions. However, there may not be any benefit of doing partitioning in this manner. The systems and methods disclosed herein provide options to prevent including a layer in a layer set in multiple bitstream partitions.

In some configurations of the systems and methods disclosed herein, each bitstream partition of a layer set may be constrained to be distinct. For example, any two bitstream partitions of a layer set may not be identical. For instance, a bitstream partition signaled in VPS VUI bitstream partition HRD parameters for a layer set may not exactly match another bitstream partition for the same layer set. Additionally or alternatively, a bitstream partition signaled in a bitstream partition HRD parameters SEI message for a layer set may not exactly match another bitstream partition for the same layer set.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

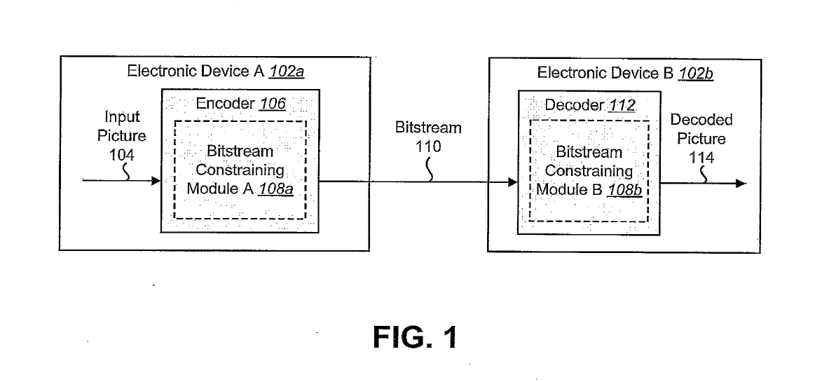

FIG. 1 is a block diagram illustrating an example of one or more electronic devices 102a-b in which systems and methods for constraining a bitstream may be implemented. In this example, electronic device A 102a and electronic device B 102b are illustrated. However, it should be noted that one or more of the features and functionality described in relation to electronic device A 102a and electronic device B 102b may be combined into a single electronic device in some configurations.

Electronic device A 102a may include an encoder 106. Each of the elements included within electronic device A 102a (e.g., one or more of the encoder 106 and bitstream constraining module A 108a) may be implemented in hardware (e.g., circuitry), or in a combination of hardware and software (e.g., a processor with instructions).

Electronic device A 102a may obtain an input picture 104. In some configurations, the input picture 104 may be captured on electronic device A 102a using an image sensor, retrieved from memory or received from another electronic device.

The encoder 106 may encode the input picture 104 to produce encoded data. For example, the encoder 106 may encode one or more (e.g., a series of) input pictures 104 (e.g., video) to produce a bitstream 110. Accordingly, the bitstream 110 may include encoded data based on the input picture 104 (e.g., encoded picture data). The encoded data may be included in a bitstream 110. In some configurations, the encoder 106 may be a HEVC encoder. In other configurations, the encoder 106 may be a SHVC or MV-HEVC encoder. In these configurations, the bitstream 110 may include coded data for more than one layer. For example, the coded bitstream 110 may include data for a base layer (e.g., a layer with nuh_layer_id_0) and one or more enhancement layers (e.g., layers with nuh_layer_id>0). nuh_layer_id may specify the identifier of the layer. In some implementations, the value of nuh_layer_id may be in the range of 0 to 62, inclusive. The value of 63 may be specified in the future by ITU-T (International Telegraph Union Telecommunication Standardization Sector)|ISO/IEC (International Organization for Standardization/International Electrotechnical Commission). Decoders may ignore all data that follow the value 63 for nuh_layer_id in a NAL unit. The encoder 106 may generate overhead data (e.g., parameters) based on the input picture 104. In some configurations, the overhead data (e.g., overhead signaling) may be included in the bitstream 110. Examples of overhead data include a picture parameter set (PPS), a sequence parameter set (SPS), a video parameter set (VPS), a slice header, etc.

In some configurations, the encoder 106 may include bitstream constraining module A 108a. In other configurations, bitstream constraining module A 108a may not be included in the encoder 106. For example, bitstream constraining module A 108a may be included in electronic device A 102a, but may be separate from the encoder 106. In yet other configurations, electronic device A 102a may not include bitstream constraining module A 108a.

Bitstream constraining module A 108a may place, enforce and/or check one or more constraints on the bitstream 110. The one or more constraints may be utilized to ensure that the bitstream is conforming and can be decoded by a conforming decoder (e.g., decoder 112). The one or more constraints may be utilized in order to increase the coding efficiency of the bitstream 110. This may help to reduce coding inefficiencies (e.g., unnecessary duplication of bitstream partitions). Additionally or alternatively, the one or more constraints may be utilized in order to check whether the bitstream 110 conforms to an operational standard. This may help to ensure compatibility of encoders and decoders.

The bitstream 110 may include one or more bitstream partitions. Bitstream partitions may be subsets of the bitstream 110 in accordance with a partitioning. The partitioning may designate or delineate the one or more bitstream partitions. Bitstream partitions may include encoded components of the input picture 104 or a series of input pictures 104. For example, a bitstream partition may include encoded data corresponding to one or more layers. Bitstream partitions may only partition based on layers in some configurations. In one example of layers, the bitstream may have layers 0, 1, 2, 3 and 4. In this example, one layer set may include layers 0, 1 and 2. One example of bitstream partitions for that layer set may be as follows: bits for layer 0 may be partition 1, while bits for layer 1 and layer 2 may be partition 2. Continuing the example, there may be another layer set that includes layers 0, 1, 3 and 4. For this layer set, the bitstream partitions may be as follows: a first bitstream partition may include bits for layers 0 and 1, while a second bitstream partition may include bits for layers 3 and 4.

The systems and methods disclosed herein may enable signaling and various constraints for bitstream partition buffer parameters. One or more of the signaling and constraints may be implemented for HEVC (e.g., SHVC, MV-HEVC, etc.). The bitstream constraints are described as follows.

A first bitstream constraint is described as follows. Bitstream constraining module A 108a may obtain a message structure. For example, the encoder 106 may generate one or more messages. Bitstream constraining module A 108a may obtain (e.g., receive) the message structure from the encoder 106. The one or more messages may include overhead information (e.g., parameters) about one or more encoded pictures. A message may include one or more message structures. Messages structures may be logical or syntactical entities that include one or more pieces of information. Examples of message structures include a VPS VUI message structure (e.g., vps_vui_bsp_hrd_parameters( )) and a bitstream partition HRD parameters SEI message structure (e.g., bsp_hrd( )).

The message structure may include a parameter structure corresponding to a bitstream partition. A parameter structure may be a logical or syntactical entity that includes one or more parameters. One example of a parameter structure is hrd_parameters( ).

Bitstream constraining module A 108a may obtain a parameter structure index referring to the parameter structure. For example, the parameter structure index may be read and/or extracted from the bitstream 110. Each parameter structure may be referred by (e.g., be associated to) an index (e.g., index value) associated with the parameter structure. Examples of parameter structure indexes include bsp_comb_hrd_idx and sei_bsp_comb_hrd_idx.

Bitstream constraining module A 108a may determine whether the parameter structure index is within a parameter structure index valid range. The parameter structure index valid range may be based on a parameter structure limiting index value. In some configurations, the parameter structure limiting index value may be a maximum index value. For example, the maximum index value may be a number of parameter structures minus 1. Examples of parameter structure limiting index values include vps_num_bsp_hrd_parameters_minus1 and sei_num_bsp_hrd_parameters_minus1. For instance, the parameter structure index valid range may include a range from 0 to vps_num_bsp_hrd_parameters_minus1. Additionally or alternatively, the parameter structure index valid range may include a range from 0 to sei_num_bsp_hrd_parameters_minus1.

Bitstream constraining module A 108a may generate a first indication if the parameter structure index is not within the parameter structure index valid range. For example, bitstream constraining module A 108a may determine whether the parameter structure index (e.g., bsp_comb_hrd_idx, sei_bsp_comb_hrd_idx) is within the parameter structure index valid range (e.g., 0 to vps_num_bsp_hrd_parameters_minus1, 0 to sei_num_bsp_hrd_parameters_minus1). If the parameter structure index is not within the parameter structure index valid range, bitstream constraining module A 108a may generate the first indication.

The first indication indicates that at least one parameter structure has an associated parameter structure index that is outside of the parameter structure index valid range. The first indication may be utilized in one or more ways. In some configurations, the encoder 106 may utilize the first indication in order to modify one or more of encoding and the bitstream 110. For example, the encoder 106 may modify the parameter structure index to ensure that it is in the valid range of values (e.g., within the parameter structure index valid range). In some configurations, the first indication may indicate that the encoder 106 does not conform to an operational standard. For example, the first indication may indicate that the encoder 106 is non-conformant with SHVC or MV-HEVC standards. This may indicate that the bitstream created by the encoder 106 may not conform with SHVC or MV-HEVC decoders. Additionally or alternatively, this may indicate that the encoder 106 functions less efficiently than encoders complying with SHVC and MV-HEVC standards. Additionally or alternatively, the encoder 106 may not allow the bitstream partition to be specified.

More specific configurations of the first bitstream constraint are given as follows. In some configurations, the first bitstream constraint ensures that when HRD parameters are signaled for a bitstream partition in VPS VUI, the signaled index of the hrd_parameters( ) structure for a bitstream partition is within a valid range of hrd_parameters( ) structures signaled in the vps_vui_bsp_hrd_parameters( ) message (e.g., syntax) structure. For example, bitstream constraining module A 108a may determine whether bsp_comb_hrd_idx[h][i][j] is within the range of 0 to vps_num_bsp_hrd_parameters_minus1, inclusive. This may be a requirement for bitstream conformance in some configurations. For instance, if bsp_comb_hrd_idx[h][i][j] is outside of the range of 0 to vps_num_bsp_hrd_parameters_minus1, bitstream constraining module A 108a may generate the first indication, which may indicate bitstream non-conformance.

It should be noted that bsp_comb_hrd_idx[h][i][j] may specify an index of hrd_parameters( ) within the vps_vui_bsp_hrd_parameters( ) syntax structure that is used in the i-th combination of a delivery schedule and hrd_parameters( ) specified for a bitstream partition with index j and for the layer set with index h. The length of the bsp_comb_hrd_idx[h][i][j] syntax element may be Ceil(Log2(vps_num_bsp_hrd_parameters_minus1+1)) bits, where vps_num_bsp_hrd_parameters_minus1+1 may indicate a number of hrd_parameters( ) structures included in the vps_vui_bsp_hrd_parameters( ) structure.

In some configurations, the first bitstream constraint ensures that when HRD parameters are signaled for a bitstream partition in an SEI message structure, the signaled index of the hrd_parameters( ) structure for a bitstream partition is within a valid range of hrd_parameters( ) structures signaled in the bsp_hrd( ) SEI message structure. For example, bitstream constraining module A 108a may determine whether sei_bsp_comb_hrd_idx[lsIdx][i][j] is within the range of 0 to sei_num_bsp_hrd_parameters_minus1, inclusive. This may be a requirement for bitstream conformance in some configurations. For instance, if sei_bsp_comb_hrd_idx[lsIdx][i][j] is outside of the range of 0 to sei_num_bsp_hrd_parameters_minus1, bitstream constraining module A 108a may generate the first indication, which may indicate bitstream non-conformance.

It should be noted that sei_bsp_comb_hrd_idx[lsIdx][i][j] may specify an index of hrd_parameters( ) within an SEI message used in the i-th combination of a delivery schedule and hrd_parameters( ) specified for the bitstream partition with index j and for a layer set with index lsIdx. The length of the sei_bsp_comb_hrd_idx[lsIdx][i][j] syntax element may be Ceil(Log2(sei_num_bsp_hrd_parameters_minus1+1)) bits, where sei_num_bsp_hrd_parameters_minus1+1 may indicate a number of hrd_parameters( ) structures included in the SEI message structure.

A second bitstream constraint is described as follows. In some configurations, the parameter structure may include a delivery schedule index and a sub-layer parameter structure. A delivery schedule may indicate information related to a bitstream hypothetical reference decoder buffer model for a bitstream partition. The delivery schedule index may provide an index corresponding to a delivery schedule. Examples of the delivery schedule index include bsp_comb_sched_idx and sei_bsp_comb_sched_idx. The sub-layer parameter structure may be logical or syntactical entity included within the parameter structure (e.g., hrd_parameters( )). One example of the sub-layer parameter structure may be a sub-layer HRD parameter structure (e.g., sub_layer_hrd_parameters( )).

In some configurations, sub_layer_hrd_parameters( ) may be defined (from Annex E of HEVC specifications with Table (1)) as follows. Sub-layer HRD parameters syntax:

TABLE (1)

| sub_layer_hrd_parameters( subLayerId ) { | Descriptor |
|---|---|
| for( i = 0; i <= CpbCnt; i++ ) { | |
| bit_rate_value_minus1[ i ] | ue(v) |
| cpb_size_value_minus1[ i ] | ue(v) |
| if( sub_pic_hrd_params_present_flag ) { | |
| cpb_size_du_value_minus1[ i ] | ue(v) |
| bit_rate_du_value_minus1[ i ] | ue(v) |
| } | |
| cbr_flag[ i ] | u(1) |
| } | |
| } | |

The variable CpbCnt is set equal to cpb_cnt_minus1[subLayerId]. bit_rate_value_minus1[i] (together with bit_rate_scale) specifies the maximum input bit rate for the i-th CPB when the CPB operates at the access unit level. bit_rate_value_minus1[i] shall be in the range of 0 to 2³²−2, inclusive. For any i>0, bit_rate_value_minus1[i] shall be greater than bit_rate_value_minus1[i−1].

When SubPicHrdFlag is equal to 0, the bit rate in bits per second is given by: BitRate[i]=(bit_rate_value_minus1[i]+1)*2^{(6+bit}^{_}^{rate}^{_}^{scale)} (E 52). When SubPicHrdFlag is equal to 0 and the bit_rate_value_minus1[i] syntax element is not present, the value of BitRate[i] is inferred to be equal to CpbBrVclFactor*MaxBR for VCL HRD parameters and to be equal to CpbBrNalFactor*MaxBR for NAL HRD parameters, where MaxBR, CpbBrVclFactor and CpbBrNalFactor are specified in subclause A.4.

cpb_size_value_minus1[i] is used together with cpb_size_scale to specify the i-th CPB size when the CPB operates at the access unit level. cpb_size_value_minus1[i ] shall be in the range of 0 to 2³²2, inclusive. For any i greater than 0, cpb_size_value_minus1[i] shall be less than or equal to cpb_size_value_minus1[i−1].

When SubPicHrdFlag is equal to 0, the CPB size in bits is given by: CpbSize[i]=(cpb_size_value_minus1[i]+1)*2^{(4+cpb}^{_}^{size}^{_}^{scale)} (E 53). When SubPicHrdFlag is equal to 0 and the cpb_size_value_minus1[i] syntax element is not present, the value of CpbSize[i] is inferred to be equal to CpbBrVclFactor*MaxCPB for VCL HRD parameters and to be equal to CpbBrNalFactor*MaxCPB for NAL HRD parameters, where MaxCPB, CpbBrVclFactor and CpbBrNalFactor are specified in subclause A.4.

cpb_size_du_value_minus1[i] is used together with cpb_size_du_scale to specify the i-th CPB size when the CPB operates at sub-picture level. cpb_size_du_value_minus1[i] shall be in the range of 0 to 2³²−2, inclusive. For any i greater than 0, cpb_size_du_value_minus1[i] shall be less than or equal to cpb_size_du_value_minus1[i−1].

When SubPicHrdFlag is equal to 1, the CPB size in bits is given by: CpbSize[i]=(cpb_size_du_value_minus1[i]+1)*2^{(4+cpb}—^{size}^{_}^{du}^{_}^{scale)} (E 54). When SubPicHrdFlag is equal to 1 and the cpb_size_du_value_minus1[i] syntax element is not present, the value of CpbSize[i] is inferred to be equal to CpbBrVclFactor*MaxCPB for VCL HRD parameters and to be equal to CpbBrNalFactor*MaxCPB for NAL HRD parameters, where MaxCPB, CpbBrVclFactor and CpbBrNalFactor are specified in subclause A.4.

bit_rate_du_value_minus1 [i] (together with bit_rate_scale) specifies the maximum input bit rate for the i-th CPB when the CPB operates at the sub-picture level. bit_rate_du_value_minus1[i] shall be in the range of 0 to 2³²−2, inclusive. For any i>0, bit_rate_du_value_minus1[i] shall be greater than bit_rate_du_value_minus1[i−1].

When SubPicHrdFlag is equal to 1, the bit rate in bits per second is given by: BitRate[i]=(bit_rate_du_value_minus1[i]+1)*2^{(6+bit}^{_}^{rate}^{_}^{scale)} (E 55). When SubPicHrdFlag is equal to 1 and the bit_rate_du_value_minus1[i] syntax element is not present, the value of BitRate[i] is inferred to be equal to CpbBrVclFactor*MaxBR for VCL HRD parameters and to be equal to CpbBrNalFactor*MaxBR for NAL HRD parameters, where MaxBR, CpbBrVclFactor and CpbBrNalFactor are specified in subclause A.4.

cbr_flag [i] equal to 0 specifies that to decode this CVS by the HRD using the i-th CPB specification, the hypothetical stream scheduler (HSS) operates in an intermittent bit rate mode. cbr_flag[i] equal to 1 specifies that the HSS operates in a constant bit rate (CBR) mode. When not present, the value of cbr_flag[i] is inferred to be equal to 0.

Bitstream constraining module A 108a may identify a delivery schedule valid range from the sub-layer parameter structure (e.g., sub-layer HRD parameter structure). The delivery schedule index valid range may be based on a delivery schedule limiting index value. In some configurations, the delivery schedule limiting index value may be a maximum index value. For example, the maximum index value may be a number of delivery schedules minus 1. The delivery schedule valid range may range between 0 and the number of delivery schedules minus 1 (e.g., cpb_cnt_minus1). One example of a delivery schedule limiting index value is cpb_cnt_minus1.

Bitstream constraining module A 108a may determine whether the delivery schedule index is within the delivery schedule valid range. For example, bitstream constraining module A 108a may determine whether the delivery schedule index (e.g., bsp_comb_sched_idx, sei_bsp_comb_sched_idx) is within the delivery schedule valid range (e.g., 0 to cpb_cnt_minus1).

More specific configurations of the second bitstream constraint are given as follows. In some configurations, the second bitstream constraint ensures that when HRD parameters are signaled for a bitstream partition in VPS VUI, the signaled index of a delivery schedule within the hrd_parameters( ) structure is within a valid range of delivery schedules signaled in the sub_layer_hrd_parameters structure in that hrd_parameters( ) structure. For example, bitstream constraining module A 108a determines whether bsp_comb_sched_idx[h][i][j] is in the range of 0 to cpb_cnt_minus1[HighestTid], inclusive, where cpb_cnt_minus1[HighestTid] is found in the sub_layer_hrd_parameters(HighestTid) structure from the hrd_parameters( ) structure corresponding to the index bsp_comb_hrd_idx[h][i][j]. HighestTid may be a highest TemporalId value. TemporalId values may be used to indicate temporal sub-layer information for the bitstream. In some configurations, TemporalId value may be derived as follows. A syntax element nuh_temporal_id_plus1 may be signaled in each NAL unit. nuh_temporal_id_plus1 minus 1 specifies a temporal identifier for the NAL unit. The value of nuh_temporal_id_plus1 shall not be equal to 0. The variable TemporalId may be specified as follows: TemporalId=nuh_temporal_id_plus1−1.

This may be a requirement for bitstream conformance in some configurations. For instance, if bsp_comb_sched_idx[h][i][j] is outside of the range of 0 to cpb_cnt_minus1[HighestTid], bitstream constraining module A 108a may generate the second indication, which may indicate bitstream non-conformance. Additionally or alternatively, bitstream constraining module A 108a may not allow the bitstream partition to be specified. It should be noted that bsp_comb_sched_idx[h][i][j] may indicate the index of a delivery schedule within the hrd_parameters( ) syntax structure with the index bsp_comb_hrd_idx[h][i][j] that is used in the i-th combination of a delivery schedule and hrd_parameters( ) specified for the bitstream partition with index j and for the layer set with index h.

In some configurations, the second bitstream constraint ensures that when HRD parameters are signaled for a bitstream partition in an SEI message, the signaled index of a delivery schedule within the hrd_parameters( ) structure is within a valid range of delivery schedules signaled in the sub_layer_hrd_parameters structure in that hrd_parameters( ) structure. For example, bitstream constraining module A 108a determines whether sei_bsp_comb_sched_idx[lsIdx][i][j] is in the range of 0 to cpb_cnt_minus1[HighestTid], inclusive, where cpb_cnt_minus1[HighestTid] is found in the sub_layer_hrd_parameters(HighestTid) structure from the hrd_parameters( ) structure corresponding to the index sei_bsp_comb_hrd_idx[lsIdx][i][j].

This may be a requirement for bitstream conformance in some configurations. For instance, if sei_bsp_comb_sched_idx[lsIdx][i][j] outside of the range of 0 to cpb_cnt_minus1[HighestTid], bitstream constraining module A 108a may generate the second indication, which may indicate bitstream non-conformance. Additionally or alternatively, bitstream constraining module A 108a may not allow the bitstream partition to be specified. It should be noted that sei_bsp_comb_sched_idx[lsIdx][i][j] may indicate the index of a delivery schedule within the hrd_parameters( ) syntax structure with the index sei_bsp_comb_hrd_idx[lsIdx][i][j] that is used in the i-th combination of a delivery schedule and hrd_parameters( ) specified for the bitstream partition with index j and for the layer set with index lsIdx.

A third bitstream constraint is described as follows. Bitstream constraining module A 108a may constrain the bitstream 110 such that if only one bitstream partition is signaled for a layer set in the message structure, the bitstream partition does not exactly match the layer set. For example, if only one bitstream partition is signaled for a layer set in the message structure (e.g., vps_vui_bsp_hrd_parameters( ), bitstream partition HRD parameters SEI message structure), bitstream constraining module A 108a may not allow the bitstream partition to exactly match the layer set. In some configurations, if the single bitstream partition exactly matches the layer set, bitstream constraining module A 108a may remove the bitstream partition. Additionally or alternatively, bitstream constraining module A 108a may remove overhead information corresponding to the bitstream partition. Additionally or alternatively, bitstream constraining module A 108a may generate a third indication if the single bitstream partition exactly matches the layer set. This may indicate bitstream non-conformance.

More specific configurations of the third bitstream constraint are given as follows. In some configurations, the third bitstream constraint ensures that when only one bitstream partition is signaled for a layer set in vps_vui_bsp_hrd_parameters( ), the bitstream partition does not exactly match the corresponding layer set. For example, when num_bitstream_partitions[h] is equal to 1, if the signaled bitstream partition exactly matches the layer set, then the HRD parameters for this can be already signaled in a VPS and the bitstream partition does not need to be signaled. In such cases, a bitstream specific CPB operation may be used instead. For example, bitstream constraining module A 108a may not allow specifying such a bitstream partition (and corresponding overhead information, for example) in this case. Additionally or alternatively, bitstream constraining module A 108a may generate a third indicator in this case. It should be noted that num_bitstream_partitions[h] may indicate a number of bitstream partitions for which HRD parameters are specified for a layer set with index h.

More specifically, when num_bitstream_partitions[h] is equal to 1 for any value of h in the range of 1 to vps_num_layer_set_minus1, inclusive, the value of layer_in_bsp_flag[h][0][j] should be equal to 0 and the value of layer_id_included_flag[h][j] should be equal to 1 for at least one value of j in the range of 0 to vps_max_layers_minus1, inclusive. This may be a requirement for bitstream conformance. It should be noted that layer_in_bsp_flag[h][i][j] specifies that the layer with index j is a part of bitstream partition with index i within the layer set with index h. In some configurations, layer_id_included_flag[i][j] equal to 1 specifies that the value of nuh_layer_id equal to j is included in the layer identifier list LayerSetLayerIdList[i]. layer_id_included_flag[i][j] equal to 0 specifies that the value of nuh_layer_id equal to j is not included in the layer identifier list LayerSetLayerIdList[i]. The value of NumLayersInIdList[0] is set equal to 1 and the value of LayerSetLayerIdList[0][0] is set equal to 0.

For each value of i in the range of 1 to vps_num_layer_sets_minus1, inclusive, the variable NumLayersInIdList[i] and the layer identifier list layerSetLayerIdList[i] may be derived as follows in Listing (1):

Listing (1)

n = 0
for( m = 0; m <= vps_max_layer_id; m++ )

if( layer_id_included_flag[ i ][ m ] )

LayerSetLayerIdList[ i ][ n++ ] = m

NumLayersInIdList[ i ] = n

For each value of i in the range of 1 to vps_num_layer_sets_minus1, inclusive, NumLayersInIdList[i] shall be in the range of 1 to vps_max_layers_minus1+1, inclusive. When NumLayersInIdList[iA] is equal to NumLayersInIdList[iB] for any iA and iB in the range of 0 to vps_num_layer_sets_minus1, inclusive, with iA not equal to iB, the value of layerSetLayerIdList[iA][n] shall not be equal to layerSetLayerIdList[iB][n] for at least one value of n in the range of 0 to numLayersInIdList[iA], inclusive. A layer set may be identified by the associated layer identifier list. The i-th layer set specified by the VPS is associated with the layer identifier list LayerSetLayerIdList[i], for i in the range of 0 to vps_num_layer_sets_minus1, inclusive. A layer set may include all operation points that are associated with the same layer identifier list. vps_max_layers_minus1+1 may indicate a maximum number of layers in a coded video sequence (CVS). It should be noted that vps_num_layer_sets_minus1 plus 1 specifies the number of layer sets that are specified by the VPS. The value of vps_num_layer_sets_minus1 may be in the range of 0 to 1023, inclusive.

One variant of the third bitstream constraint (based on JCTVC-P0184v4) is described as follows. When num_bitstream_partitions[h] is equal to 1 for any value of h in the range of 1 to vps_num_layer_set_minus1, inclusive, the value of layer_in_bsp_flag[h][0][j] should be equal to 0 for at least one value of j in the range of 0 to NumLayersInIdList[h]−1, inclusive. This may be a requirement for bitstream conformance. Bitstream constraining module A 108a may perform one or more of not allowing the bitstream partition to be specified, removing the bitstream partition information (from the bitstream 110) and generating a third indicator if this condition of the third bitstream constraint is not met. It should be noted that num_bitstream_partitions[h] may indicate a number of bitstream partitions for which HRD parameters are specified for a layer set with index h. Additionally, NumLayersInIdList[h] is described above.

In other configurations, if only one bitstream partition is signaled for a layer set in the message structure, the bitstream partition may be allowed to match the layer set if no parameters in the message structure (e.g., vps_vui_bsp_hrd_parameters( )) are signaled for the layer set. For example, the third bitstream constraint may be relaxed to allow defining a bitstream partition for a layer set in vps_vui_bsp_hrd_parameters( ) to match that layer set if there are no HRD parameters signaled in VPS for the layer set. More specifically, when num_bitstream_partitions[h] is equal to 1 for any value of h in the range of 1 to vps_num_layer_set_minus1, inclusive, and layer_in_bsp_flag[h][0][j] is equal to the value of layer_id_included_flag[h][j] for all values of j in the range of 0 to vps_max_layers_minus1, inclusive, hrd_layer_set_idx[k] should not be equal to h for any value of k in the range of 0 to vps_num_hrd_parameters−1, inclusive. This may be a requirement for bitstream conformance. If this bitstream constraint condition is not met, bitstream constraining module A 108a may perform one or more of not allowing the bitstream partition to be specified, removing overhead information corresponding to the bitstream partition and generating a third indicator.

vps_num_hrd_parameters specifies the number of hrd_parameters( ) syntax structures present in the VPS raw byte sequence payload (RBSP). The value of vps_num_hrd_parameters shall be in the range of 0 to vps_num_layer_sets_minus1+1, inclusive. hrd_layer_set_idx[i] specifies the index, into the list of layer sets specified by the VPS, of the layer set to which the i th hrd_parameters( ) syntax structure in the VPS applies. The value of hrd_layer_set_idx[i] shall be in the range of (vps_base_layer_internal_flag ? 0:1) to vps_num_layer_sets_minus1, inclusive. It is a requirement of bitstream conformance that the value of hrd_layer_set_idx[i] shall not be equal to the value of hrd_layer_set_idx[j] for any value of j not equal to i.

One variant of the relaxed third bitstream constraint (based on JCTVC-P0184v4) is given as follows. When num_bitstream_partitions[h] is equal to 1 for any value of h in the range of 1 to vps_num_layer_set_minus1, inclusive, and layer_in_bsp_flag[h][0][j] is equal to 1 for all values of j in the range of 0 to NumLayersInIdList[h]−1, inclusive, hrd_layer_set_idx[k] should not be equal to h for any value of k in the range of 0 to vps_num_hrd_parameters−1, inclusive. This may be a requirement for bitstream conformance. If this bitstream constraint condition is not met, bitstream constraining module A 108a may perform one or more of not allowing the bitstream partition to be specified, removing the bitstream partition information (from the bitstream 110), removing overhead information corresponding to the bitstream partition and generating a third indicator.

In yet other configurations, if only one bitstream partition is signaled for a layer set in the message structure, the bitstream partition may be allowed to match the layer set if parameters specific to the bitstream partition match any parameters signaled in the message structure for the layer set. For example, the third bitstream constraint may be relaxed to allow defining a bitstream partition for a layer set in vps_vui_bsp_hrd_parameters( ) to match that layer set, where the signaled bitstream partition specific HRD parameters should match those signaled in the VPS for the layer set, if any. More specifically, when num_bitstream_partitions[h] is equal to 1 for any value of h in the range of 1 to vps_num_layer_set_minus1, inclusive, and layer_in_bsp_flag[h][0][j] is equal to the value of layer_id_included_flag[h][j] for all values of j in the range of 0 to vps_max_layers_minus1, inclusive, and hrd_layer_set_idx[k] is equal to h for any value of k in the range of 0 to vps_num_hrd_parameters−1, inclusive, the HRD parameters for the bitstream partition signaled in vps_vui_bsp_hrd_parameters( ) should match the HRD parameters signaled in VPS for the layer set h. This may be a requirement for bitstream conformance. If this bitstream constraint condition is not met, bitstream constraining module A 108a may perform one or more of not allowing the bitstream partition to be specified, removing the bitstream partition information (from the bitstream 110), removing overhead information corresponding to the bitstream partition and generating a third indicator. It should be noted that vps_num_hrd_parameters is described above.

Another variant of the relaxed third bitstream constraint (based on JCTVC-P0184v4) is given as follows. When num_bitstream_partitions[h] is equal to 1 for any value of h in the range of 1 to vps_num_layer_set_minus1, inclusive, layer_in_bsp_flag[h][0][j] is equal to 1 for all values of j in the range of 0 to NumLayersInIdList[h]−1, inclusive, and hrd_layer_set_idx[k] is equal to h for any value of k in the range of 0 to vps_num_hrd_parameters−1, inclusive, the HRD parameters for the bitstream partition signaled in vps_vui_bsp_hrd_parameters( ) should match the HRD parameters signaled in VPS for the layer set h. This may be a requirement for bitstream conformance. If this bitstream constraint condition is not met, bitstream constraining module A 108a may perform one or more of not allowing the bitstream partition to be specified, removing the bitstream partition information (from the bitstream 110), removing overhead information corresponding to the bitstream partition and generating a third indicator.

In some configurations, the third bitstream constraint ensures that when only one bitstream partition is signaled for a layer set in a bitstream partition HRD parameters SEI message structure (e.g., bsp_hrd( )), the bitstream partition does not exactly match the corresponding layer set. For example, when num_sei_bitstream_partitions_minus1[lsIdx] is equal to 0, if the signaled bitstream partition exactly matches the layer set, then the HRD parameters for this can be already signaled in a VPS and the bitstream partition does not need to be signaled. In such cases, a bitstream specific CPB operation may be used instead. For example, bitstream constraining module A 108a may remove (from the bitstream 110) the bitstream partition information (and corresponding overhead information, for example) in this case. Additionally or alternatively, bitstream constraining module A 108a may generate a third indicator in this case. It should be noted that num_sei_bitstream_partitions_minus1[lsIdx]+1 may indicate the number of bitstream partitions for which HRD parameters are specified for the layer set with index lsIdx.

More specifically, when num_sei_bitstream_partitions_minus1[lsIdx] is equal to 0 for any value of h in the range of 0 to nesting_num_ops_minus1, inclusive, the value of sei_layer_in_bsp_flag[lsIdx][0][j] should be equal to 0 and the value of layer_id_included_flag[lsIdx][j] should be equal to 1 for at least one value of j in the range of 0 to vps_max_layers_minus1, inclusive. This may be a requirement for bitstream conformance. It should be noted that sei_layer_in_bsp_flag[lsIdx][i][j] may indicate that the layer with index LayerSetLayerIdList[lsIdx][j] is a part of bitstream partition with index i within the layer set with index lsIdx, where LayerSetLayerIdList[lsIdx][j] is described above. When not present, the value of sei_layer_in_bsp_flag[h][i][j] may be inferred to be equal to 0.

Another variant of the third bitstream constraint (based on JCTVC-P0184v4) is given as follows. When num_sei_bitstream_partitions_minus1[lsIdx] is equal to 0 for any value of h in the range of 0 to nesting_num_ops_minus1, inclusive, the value of sei_layer_in_bsp_flag[lsIdx][0][j] should be equal to 0 for at least one value of j in the range of 0 to NumLayersInIdList[lsIdx]−1, inclusive. This may be a requirement for bitstream conformance. Bitstream constraining module A 108a may perform one or more of not allowing the bitstream partition to be specified, removing the bitstream partition information (from the bitstream 110) and generating a third indicator if this condition of the third bitstream constraint is not met. nesting_num_ops_minus1 plus 1 minus default_op_flag specifies the number of the following nesting_op_idx[i] syntax elements. The value of nesting_num_ops_minus1 may be in the range of 0 to 1023, inclusive. default_op_flag equal to 1 specifies that maxTemporalId[0] is equal to nuh_temporal_id_plus1 of the current SEI NAL unit minus 1 and that nestingLayerIdList[0] contains all integer values in the range of 0 to nuh_layer_id of the current SEI NAL unit, inclusive, in increasing order of the values.

In other configurations, if only one bitstream partition is signaled for a layer set in the message structure (e.g., bsp_hrd( )), the bitstream partition may be allowed to match the layer set if no parameters in the VPS are signaled for the layer set. For example, the third bitstream constraint may be relaxed to allow defining a bitstream partition for a layer set in the bitstream partition HRD parameters SEI message structure (e.g., bsp_hrd( )) to match that layer set if there are no HRD parameters signaled in the VPS for the layer set. More specifically, when num_sei_bitstream_partitions_minus1[lsIdx] is equal to 0 for any value of h in the range of 0 to nesting_num_ops_minus1, inclusive, and sei_layer_in_bsp_flag[lsIdx][0][j] is equal to the value of layer_id_included_flag[lsIdx][j] for all values of j in the range of 0 to vps_max_layers_minus1, inclusive, hrd_layer_set_idx[k] should not be equal to lsIdx for any value of k in the range of 0 to vps_num_hrd_parameters−1, inclusive. This may be a requirement for bitstream conformance. If this bitstream constraint condition is not met, bitstream constraining module A 108a may perform one or more of not allowing the bitstream partition to be specified, removing the bitstream partition information (from the bitstream 110), removing overhead information corresponding to the bitstream partition and generating a third indicator.

Another variant of the relaxed third bitstream constraint (based on JCTVC-P0184v4) is given as follows. When num_sei_bitstream_partitions_minus1[lsIdx] is equal to 0 for any value of h in the range of 0 to nesting_num_ops_minus1, inclusive, and layer_in_bsp_flag[lsIdx][0][j] is equal to 1 for all values of j in the range of 0 to NumLayersInIdList[lsIdx]−1, inclusive, hrd_layer_set_idx[k] should not be equal to lsIdx for any value of k in the range of 0 to vps_num_hrd_parameters−1, inclusive. This may be a requirement for bitstream conformance. If this bitstream constraint condition is not met, bitstream constraining module A 108a may perform one or more of not allowing the bitstream partition to be specified, removing the bitstream partition information (from the bitstream 110), removing overhead information corresponding to the bitstream partition and generating a third indicator.

In yet other configurations, if only one bitstream partition is signaled for a layer set in the message structure (e.g., bsp_hrd( )), the bitstream partition may be allowed to match the layer set if parameters specific to the bitstream partition match any parameters signaled in the VPS for the layer set. For example, the third bitstream constraint may be relaxed to allow defining a bitstream partition for a layer set in the bitstream partition HRD parameters SEI message structure (e.g., bsp_hrd( )) to match that layer set, where the signaled bitstream partition specific HRD parameters should match those signaled in the VPS for the layer set, if any. More specifically, when num_sei_bitstream_partitions_minus1[lsIdx] is equal to 0 for any value of h in the range of 0 to nesting_num_ops_minus1, inclusive, and sei_layer_in_bsp_flag[lsIdx][0][j] is equal to the value of layer_id_included_flag[lsIdx][j] for all values of j in the range of 0 to vps_max_layers_minus1, inclusive, and hrd_layer_set_idx[k] is equal to lsIdx for any value of k in the range of 0 to vps_num_hrd_parameters−1, inclusive, the HRD parameters for the bitstream partition signaled in bsp_hrd( ) should match the HRD parameters signaled in VPS for the layer set lsIdx. This may be a requirement for bitstream conformance. If this bitstream constraint condition is not met, bitstream constraining module A 108a may perform one or more of not allowing the bitstream partition to be specified, removing the bitstream partition information (from the bitstream 110), removing overhead information corresponding to the bitstream partition and generating a third indicator.

Another variant of the relaxed third bitstream constraint (based on JCTVC-P0184v4) is given as follows. When num_sei_bitstream_partitions_minus1[lsIdx] is equal to 0 for any value of h in the range of 0 to nesting_num_ops_minus1, inclusive, sei_layer_in_bsp_flag[lsIdx][0][j] is equal to 1 for all values of j in the range of 0 to NumLayersInIdList[lsIdx]−1, inclusive, and hrd_layer_set_idx[k] is equal to h for any value of k in the range of 0 to vps_num_hrd_parameters−1, inclusive, the HRD parameters for the bitstream partition signaled in bsp_hrd( ) should match the HRD parameters signaled in VPS for the layer set lsIdx. This may be a requirement for bitstream conformance. If this bitstream constraint condition is not met, bitstream constraining module A 108a may perform one or more of not allowing the bitstream partition to be specified, removing the bitstream partition information (from the bitstream 110), removing overhead information corresponding to the bitstream partition and generating a third indicator.

A fourth bitstream constraint is described as follows. Bitstream constraining module A 108a may constrain the bitstream 110 such that the parameter structure index is coded using a fixed length coding scheme. In known approaches, a parameter structure index may be coded using a variable length coding scheme. This may be a requirement for bitstream conformance. If this bitstream constraint condition is not met, bitstream constraining module A 108a may perform one or more of not allowing the bitstream partition to be specified, recoding the parameter structure index using a fixed length coding scheme and generating a fourth indicator. The fourth indicator may indicate bitstream non-compliance. The fixed length encoding and decoding may beneficially have lower complexity than variable length encoding and decoding.

In some configurations, there is a limited range of values that can be assigned to the bsp_comb_hrd_idx[h][i][j] syntax element in VPS VUI HRD parameters (e.g., vps_vui_bsp_hrd_parameters( )) syntax. Furthermore, it is unlikely that some index values are taken more often than others. Accordingly, a fixed length coding scheme (e.g., u(v) coding) may be utilized for this syntax element instead of a variable length coding scheme (e.g., ue(v) coding) that is used in known approaches.

In some configurations, the fixed length coding scheme (e.g., u(v) coding) and the variable length coding scheme (e.g., ue(v) coding) may be defined as follows. u(n) may denote an unsigned integer using n bits. When n is “v” in the syntax table, the number of bits varies in a manner dependent on the value of other syntax elements. It should be noted that while “v” may vary, u(v) coding may be referred to as fixed length coding. In particular, the length may be determined based on some syntax elements. However, once that length is determined, the coding length may be fixed. The parsing process for this descriptor is specified by the return value of a function read bits(n) interpreted as a binary representation of an unsigned integer with a most significant bit written first. ue(v) may denote an unsigned integer 0-th order Exp-Golomb-coded syntax element with the left bit first. The parsing process for this descriptor may be specified in subclause 9.2 of the HEVC coding standard. Accordingly, u(v) coding may be referred to as fixed length coding and ue(v) may be referred to as variable length coding with entropy coding.

Syntax Table (2) provides one example of a vps_vui_bsp_hrd_parameters( ) message structure (from section F.7.3.2.1.6 (VPS VUI bitstream partition HRD parameters syntax) of JCTVC-P1008v4). However, syntax Table (2) illustrates that bsp_comb_hrd_idx[h][i][j] is coded with a fixed length coding scheme (e.g., u(v)) instead of a variable length coding scheme (e.g., ue(v)). bsp_comb_hrd_idx[h][i][j] may be one example of a parameter structure index as described above.

TABLE (2)

| vps_vui_bsp_hrd_parameters( ){ | Descriptor |
|---|---|
| vps_num_bsp_hrd_parameters_minus1 | ue(v) |
| ... | u(1) |
| if( num_bitstream_partitions[ h ]) { | |
| num_bsp_sched_combinations[ h ] | ue(v) |
| for( i = 0; i < num_bsp_sched_combinations[ h ]; | |
| i++ ) | |
| for( j = 0; j < num_bitstream_partitions[ h ]; | |
| j++ ) { | |
| bsp_comb_hrd_idx[ h ][ i ][ j ] | u(v) [symbol] |
| bsp_comb_sched_idx[ h ][ i ][ j ] | ue(v) |
| } | |
| } | |
| } | |
| } | |

In Table (2), bsp_comb_hrd_idx[h][i][j] may specify an index of hrd_parameters( ) within the vps_vui_bsp_hrd_parameters( ) syntax structure that is used in the i-th combination of a delivery schedule and hrd_parameters( ) specified for a bitstream partition with index j and for the layer set with index h. The length of the bsp_comb_hrd_idx[h][i][j] syntax element may be Ceil(Log2(vps_num_bsp_hrd_parameters_minus1+1)) bits. Additionally, num_bsp_sched_combinations[h] may indicate the number of combinations of delivery schedules and hrd_parameters( ) specified for bitstream partitions for the layer set with index h.

In some configurations, there is a limited range of values that can be assigned to the sei_bsp_comb_hrd_idx[lsIdx][i][j] syntax element in bitstream partition HRD parameters SEI message (e.g., bsp_hrd( )) syntax. Furthermore, it is unlikely that some index values are taken more often than others. Accordingly, a fixed length coding scheme (e.g., u(v) coding) may be utilized for this syntax element instead of a variable length coding scheme (e.g., ue(v) coding) that is used in known approaches.

Syntax Table (3) provides one example of a bsp_hrd( ) message structure (from section F.14.1.5 (Bitstream partition HRD parameters SEI message syntax)). However, syntax Table (3) illustrates that sei_bsp_comb_hrd_idx[lsIdx][i][j] is coded with a fixed length coding scheme (e.g., u(v)) instead of a variable length coding scheme (e.g., ue(v)). sei_bsp_comb_hrd_idx[lsIdx][i][j] may be one example of a parameter structure index as described above.

TABLE (3)

| bsp_hrd( payloadSize ) { | Descriptor |
|---|---|
| sei_num_bsp_hrd_parameters_minus1 | ue(v) |
| for( i = 0; i <= sei_num_bsp_hrd_parameters_minus1; i++ ) { | |
| if( i > 0 ) | |
| sei_bsp_cprms_present_flag[ i ] | u(1) |
| hrd_parameters( sei_bsp_cprms_present_flag[ i ], | |
| nesting_max_temporal_id_plus1[ 0 ] − 1 ) | |
| } | |
| for( h=0; h <= nesting_num_ops_minus1; h++ ) { | |
| lsIdx = nesting_op_idx[ h ] | |
| num_sei_bitstream_partitions_minus1[ lsIdx ] | ue(v) |
| for( i = 0; i <= num_sei_bitstream_partitions_minus1[ lsIdx ]; i++ ) | |
| for( j = 0; j <= vps_max_layers_minus1; j++ ) | |
| if( layer_id_included_flag[ lsIdx ][ j ] ) | |
| sei_layer_in_bsp_flag[ lsIdx ][ i ][ j ] | u(1) |
| sei_num_bsp_sched_combinations_minus1[ lsIdx ] | ue(v) |
| for( i = 0; i <= sei_num_bsp_sched_combinations_minus1[ lsIdx ]; i++ ) | |
| for( j = 0; j <= num_sei_bitstream_partitions_minus1[ lsIdx ]; j++ ) | |
| { | |
| sei_bsp_comb_hrd_idx[ lsIdx ][ i ][ j ] | u(v) [symbol] |
| sei_bsp_comb_sched_idx[ lsIdx ][ i ][ j ] | ue(v) |
| } | |
| } | |
| } | |

In Table (3), sei_bsp_comb_hrd_idx[lsIdx][i][j] may indicate the index of hrd_parameters( ) within the SEI message used in the i-th combination of a delivery schedule and hrd_parameters( ) specified for the bitstream partition with index j and for the layer set with index lsIdx. The length of the sei_bsp_comb_hrd_idx[lsIdx][i][j] syntax element may be Ceil(Log2(sei_num_bsp_hrd_parameters_minus1+1)) bits. payloadSize may be an input parameter to the SEI message. sei_num_bsp_hrd_parameters_minus1 plus 1 may indicate the number of hrd_parameters( ) syntax structures included in the SEI message structure. When sei_bsp_cprms_present_flag[i] is equal to 1, this may indicate that the HRD parameters that are common for all sub-layers are included in the i-th hrd_parameters( ) syntax structure in the SEI message structure. When sei_bsp_cprms_present_flag[i] is equal to 0, this may indicate that the HRD parameters that are common for all sub-layers are not included in the i-th hrd_parameters( ) syntax structure in the SEI message structure and may be derived to be the same as the (i−1)-th hrd_parameters( ) syntax structure in the SEI message structure. sei_bsp_cprms_present_flag[0] may be inferred to be equal to 1. nesting_max_temporal_id_plus1 [i] is used to specify the variable maxTemporalId[i]. The value of nesting_max_temporal_id_plus1[i] shall be greater than or equal to nuh_temporal_id_plus1 of the current SEI NAL unit. The variable maxTemporalId[i] is set equal to nesting_max_temporal_id_plus1[i]−1. nesting_op_idx [i] is used to specify the list nestingLayerIdList[i]. The value of nesting_op_idx[i] may be in the range of 0 to 1023, inclusive. The list nestingLayerIdList[i] is set equal to the OpLayerIdList of the nesting_op_idx[i]-th layer set specified by the active VPS. sei_num_bsp_sched_combinations_minus1[lsIdx]plus 1 may indicate the number of combinations of delivery schedules and hrd_parameters( ) specified for bitstream partitions for the layer set with index lsIdx.

A fifth bitstream constraint is described as follows. Bitstream constraining module A 108a may constrain the bitstream 110 such that any layer in a layer set is not included in more than one bitstream partition. This may be a requirement for bitstream conformance. If this bitstream constraint condition is not met, bitstream constraining module A 108a may perform one or more of not allowing the bitstream partition to be specified, removing one or more such bitstream partitions' information (from the bitstream 110), removing overhead information corresponding to the one or more such bitstream partitions and generating a fifth indicator. The fifth indicator may indicate bitstream non-compliance.

In known approaches for signaling bitstream partition specific HRD parameters in vps_vui_bsp_hrd_parameters( ), it is possible to include a layer in a layer set in multiple bitstream partitions. This may result in lower efficiency in coding and resource usage. Also, the HRD parameters signaled for partitions in this case may require strict checks to make sure that they are correct. Accordingly, it may not be beneficial to perform partitioning in this manner. For example, if this known approach is allowed, duplicate partitions could be signaled. The systems and methods disclosed herein provide options to accomplish the fifth bitstream constraint. A first option may be beneficial by reducing the number of signaling bits in comparison to a known signaling approach.

In one example of the first option, signaling in vps_vui_bsp_hrd_parameters( ) may be modified to disallow including the same layer in a layer set in more than one bitstream partition of that layer set. Syntax Table (4) provides one example of a vps_vui_bsp_hrd_parameters( ) message structure (from section F.7.3.2.1.6 (VPS VUI bitstream partition HRD parameters syntax) of JCTVC-P1008v4). However, syntax Table (4) illustrates one example of an implementation of the fifth bitstream constraint. In particular, the syntax “for(k=0, LayerIdPrevIncluded[h][j]=0; k<i; k++),” “LayerIdPrevIncluded[h][j]=LayerIdPrevIncluded[h][j]|Layer_in_bsp_flag[h][k][j]” and “if(layer_id_included_flag[h][j] && !LayerIdPrevIncluded[h][j])” may be utilized to implement the fifth bitstream constraint, where | denotes a bit-wise “or.” When operating on integer arguments, operations may be performed on a two's complement representation of the integer value. When operating on a binary argument that contains fewer bits than another argument, the shorter argument is extended by adding more significant bits equal to 0.

TABLE (4)

| vps_vui_bsp_hrd_parameters( ){ | Descriptor |
|---|---|
| vps_num_bsp_hrd_parameters_minus1 | ue(v) |
| for( i = 0; i <= vps_num_bsp_hrd_parameters_minus1; i++ ) { | |
| if( i > 0 ) | |
| bsp_cprms_present_flag[ i ] | u(1) |
| hrd_parameters( bsp_cprms_present_flag[ i ], | |
| vps_max_sub_layers_minus1 ) | |
| } | |
| for( h=1; h <= vps_num_layer_sets_minus1; h++ ) { | |
| num_bitstream_partitions[ h ] | ue(v) |
| for( i = 0; i < num_bitstream_partitions[ h ]; i++ ) | |
| for( j = 0; j <= vps_max_layers_minus1; j++ ) | |
| for( k=0, LayerIdPrevIncluded[ h ][ j ]=0; k < i; k++) | |
| LayerIdPrevIncluded[ h ][ j ]= LayerIdPrevIncluded[ h ][ j ] \| | |
| layer_in_bsp_flag[ h ][ k ][ j ] | |
| if( layer_id_included_flag[ h ][ j ] | |
| && !LayerIdPrevIncluded[ h ][ j ]) | |
| layer_in_bsp_flag[ h ][ i ][ j ] | u(1) |
| if( num_bitstream_partitions[ h ] ) { | |
| num_bsp_sched_combinations[ h ] | ue(v) |
| for( i = 0; i < num_bsp_sched_combinations[ h ]; i++ ) | |
| for( j = 0; j < num_bitstream_partitions[ h ]; j++ ) { | |
| bsp_comb_hrd_idx[ h ][ i ][ j ] | ue(v) |
| bsp_comb_sched_idx[ h ][ i ][ j ] | ue(v) |
| } | |
| } | |
| } | |
| } | |

In Table (4), when bsp_cprms_present_flag[i] is equal to 1, this may indicate that the HRD parameters that are common for all sub-layers are present in the i-th hrd_parameters( ) syntax structure in the vps_vui_bsp_hrd_parameters( ) syntax structure. When bsp_cprms_present_flag[i] is equal to 0, this may indicate that the HRD parameters that are common for all sub-layers are not present in the i-th hrd_parameters( ) syntax structure in the vps_vui_bsp_hrd_parameters( ) syntax structure and are derived to be the same as the (i−1)-th hrd_parameters( ) syntax structure in the in the vps_vui_bsp_hrd_parameters( ) syntax structure. bsp_cprms_present_flag[0] may be inferred to be equal to 1. vps_max_sub_layers_minus1 plus 1 specifies the maximum number of temporal sub-layers that may be present in each coded video sequence (CVS) referring to the VPS. The value of vps_max_sub_layers_minus1 may be in the range of 0 to 6, inclusive. LayerIdPrevIncluded is a variable that keeps track of whether a particular layer is already included in one of the partitions of the layer set.

One variant of LayerIdPrevIncluded may be defined in VPS VUI bitstream partition

HRD parameters semantics in Listing (2) (which may be applied to section F.7.4.3.1.6 of JCTVC-P1008v4 (VPS VUI bitstream partition HRD parameters semantics), for example):

Listing (2)

For each i in the range of 0 to num_bitstream_partitions[ h ]−1, inclusive, for each j in the range
of 0 to vps_max_layers_minus1, inclusive, the variable LayerIdPrevIncluded is derived as
follows:
for( k=0, LayerIdPrevIncluded[ h ][ j ]=0; k < i; k++)
{

LayerIdPrevIncluded[ h ][ j ]= LayerIdPrevIncluded[ h ][ j ] | layer_in_bsp_flag[ h ][ k ][ j ]

}
layer_in_bsp_flag[ h ][ i ][ j ] specifies that the layer with index j is a part of bitstream partition
with index i within the layer set with index h.
It is a requirement of bitstream conformance that bitstream partition with index j shall not
include direct or indirect reference layers of any layers in bitstream partition i for any values of i
and j in the range of 0 to num_bitstream_partitions[ h ] − 1, inclusive, such that i is less than j.

Another variant of the fifth bitstream constraint (based on JCTVC-P0184v4) is described as follows. Syntax Table (5) provides another example of a vps_vui_bsp_hrd_parameters( ) message structure (from section F.7.3.2.1.6 (VPS VUI bitstream partition HRD parameters syntax) of JCTVC-P1008v4). However, syntax Table (5) illustrates another example of an implementation of the fifth bitstream constraint. In particular, the syntax “for(k=0, LayerIdPrevIncluded[h][j]=0; k<i; k++),” “LayerIdPrevIncluded[h][j]=LayerIdPrevIncluded[h][j]|layer_in_bsp_flag[h][k][j]” and “if(!LayerIdPrevIncluded[h][j])” may be utilized to implement the fifth bitstream constraint.

TABLE (5)

| vps_vui_bsp_hrd_parameters( ){ | Descriptor |
|---|---|
| vps_num_bsp_hrd_parameters_minus1 | ue(v) |
| for( i = 0; i <= vps_num_bsp_hrd_parameters_minus1; i++ ) { | |
| if( i > 0 ) | |
| bsp_cprms_present_flag[ i ] | u(1) |
| hrd_parameters( bsp_cprms_present_flag[ i ], | |
| vps_max_sub_layers_minus1 ) | |
| } | |
| for( h=1; h <= vps_num_layer_sets_minus1; h++ ) { | |
| num_bitstream_partitions[ h ] | ue(v) |
| for( i = 0; i < num_bitstream_partitions[ h ]; i++ ) | |
| for( j = 0; j <= NumLayersInIdList[ h ]; j++ ) | |
| for( k=0, LayerIdPrevIncluded[ h ][ j ]=0; k < i; k++) | |
| LayerIdPrevIncluded[ h ][ j ]= LayerIdPrevIncluded[ h ][ j ] \| | |
| layer_in_bsp_flag[ h ][ k ][ j ] | |
| if(!LayerIdPrevIncluded[ h ][ j ]) | |
| layer_in_bsp_flag[ h ][ i ][ j ] | u(1) |
| if( num_bitstream_partitions[ h ] ) { | |
| num_bsp_sched_combinations[ h ] | ue(v) |
| for( i = 0; i < num_bsp_sched_combinations[ h ]; i++ ) | |
| for( j = 0; j < num_bitstream_partitions[ h ]; j++ ) { | |
| bsp_comb_hrd_idx[ h ][ i ][ j ] | ue(v) |
| bsp_comb_sched_idx[ h ][ i ][ j ] | ue(v) |
| } | |
| } | |
| } | |
| } | |

Another variant of LayerIdPrevIncluded may be defined in VPS VUI bitstream partition HRD parameters semantics in Listing (3) (which may be applied to section F.7.4.3.1.6 of JCTVC-P1008v4 (VPS VUI bitstream partition HRD parameters semantics), for example):

For each i in the range of 0 to num_bitstream_partitions[h]−1, inclusive, for each j in the range of 0 to vps_max_layers_minus1, inclusive, the variable LayerIdPrevIncluded is derived as follows:

Listing (3)

for( k=0, LayerIdPrevIncluded[ h ][ j ]=0; k < i; k++)

LayerIdPrevIncluded[ h ][ j ]= LayerIdPrevIncluded[ h ][ j ] | layer_in_bsp_flag[ h ][ k ][ j ]

layer_in_bsp_flag[ h ][ i ][ j ] specifies that the layer with index LayerSetLayerIdList[ h ][ j ] is
a part of bitstream partition with index i within the layer set with index h. When not present, the
value of layer_in_bsp_flag[ h ][ i ][ j ] is inferred to be equal to 0.
It is a requirement of bitstream conformance that bitstream partition with index j shall not
include direct or indirect reference layers of any layers in bitstream partition i for any values of i
and j in the range of 0 to num_bitstream_partitions[ h ] − 1, inclusive, such that i is less than j.
It is a requirement of bitstream conformance that, when vps_base_layer_internal_flag is equal to
0 and layer_in_bsp_flag[ h ][ i ][ 0 ] is equal to 1 for any value of h in the range of 1 to
vps_num_layer_sets_minus1, inclusive, and any value of i in the range of 0 to
num_bitstream_partitions[ h ] − 1, inclusive, the value of layer_in_bsp_flag[ h ][ i ][ j ] for at
least one value of j in the range of 1 to NumLayersInIdList[ h ] − 1, inclusive, shall be equal to 1.

vps_base_layer_internal_flag equal to 0 specifies that the base layer is provided by an external means. vps_base_layer_internal_flag equal to 1 specifies that the base layer is provided in the bitstream. When vps_base_layer_internal_flag is equal to 0, the following applies: The value of vps_sub_layer_ordering_info_present_flag shall be equal to 0. The values of vps_max_dec_pic_buffering_minus1[i], vps_max_num_reorder_pics[i] and vps_max_latency_increase_plus1[i] shall all be equal to 0 for all possible values of i. Decoders shall ignore the values of vps_sub_layer_ordering_info_present_flag, vps_max_dec_pic_buffering_minus1[i], vps_max_num_reorder_pics[i], and vps_max_latency_increase_plus1[i]. The value of hrd_layer_set_idx[i] shall be greater than 0.

Another variant of the fifth bitstream constraint (based on JCTVC-P0184v4) is described as follows. Syntax Table (6) provides another example of a vps_vui_bsp_hrd_parameters( ) message structure (from section F.7.3.2.1.6 (VPS VUI bitstream partition HRD parameters syntax) of JCTVC-P1008v4). However, syntax Table (6) illustrates another example of an implementation of the fifth bitstream constraint. In particular, the syntax “lIdx=LayerSetLayerIdList[h][j],” “for(k=0, LayerIdPrevIncluded[h][j]=0; k<i; k++),” “for(m=0; m<NumLayersInIdList[h]; m++),” “if(lIdx==LayerSetLayerIdList[h][m],” “LayerIdPrevIncluded[h][j]=LayerIdPrevIncluded[h][j]|layer_in_bsp_flag[h][k][m]” and “if(!LayerIdPrevIncluded[h][j])” may be utilized to implement the fifth bitstream constraint. lIdx is a variable used to keep track of LayerSetLayerIdList[h][j].

TABLE (6)

| vps_vui_bsp_hrd_parameters( ){ | Descriptor |
|---|---|
| vps_num_bsp_hrd_parameters_minus1 | ue(v) |
| for( i = 0; i <= vps_num_bsp_hrd_parameters_minus1; i++ ) { | |
| if(i > 0 ) | |
| bsp_cprms_present_flag[ i ] | u(1) |
| hrd_parameters( bsp_cprms_present_flag[ i ], | |
| vps_max_sub_layers_minus1 ) | |
| } | |
| for( h=1; h <= vps_num_layer_sets_minus1; h++ ) { | |
| num_bitstream_partitions[ h ] | ue(v) |
| for( i = 0; i < num_bitstream_partitions[ h ]; i++ ) | |
| for( j = 0; j <= NumLayersInIdList[ h ]; j++ ) | |
| lIdx= LayerSetLayerIdList[ h ][ j ] | |
| for( k=0, LayerIdPrevIncluded[ h ][ j ]=0; k < i; k++) | |
| for( m=0; m < NumLayersInIdList[ h ]; m++) | |
| if(lIdx== LayerSetLayerIdList[ h ][ m ] | |
| LayerIdPrevIncluded[ h ][ j ]= LayerIdPrevIncluded[ h ][ j ] \| | |
| layer_in_bsp_flag[ h ][ k ][ m ] | |
| if(!LayerIdPrevIncluded[ h ][ j ]) | |
| layer_in_bsp_flag[ h ][ i ][ j ] | u(1) |
| if( num_bitstream_partitions[ h ] ) { | |
| num_bsp_sched_combinations[ h ] | ue(v) |
| for( i = 0; i < num_bsp_sched_combinations[ h ]; i++ ) | |
| for( j = 0; j < num_bitstream_partitions[ h ]; j++ ) { | |
| bsp_comb_hrd_idx[ h ][ i ][ j ] | ue(v) |
| bsp_comb_sched_idx[ h ][ i ][ j ] | ue(v) |
| } | |
| } | |
| } | |
| } | |

Another variant of LayerIdPrevIncluded may be defined in VPS VUI bitstream partition HRD parameters semantics in Listing (4) (which may be applied to section F.7.4.3.1.6 of JCTVC-P1008v4 (VPS VUI bitstream partition HRD parameters semantics), for example):

Listing (4)

For each i in the range of 0 to num_bitstream_partitions[ h ]−1, inclusive, for each j in the range
of 0 to vps_max_layers_minus1, inclusive, the variable LayerIdPrevIncluded is derived as
follows:
1Idx== LayerSetLayerIdList[ h ][ j ];
for( k=0, LayerIdPrevIncluded[ h ][ j ]=0; k < i; k++)

for( m=0; m < NumLayersInIdList[ h ]; m++)

if(1Idx= LayerSetLayerIdList[ h ][ m ])
LayerIdPrevIncluded[ h ][ j ]= LayerIdPrevIncluded[ h ][ j ] |

layer_in_bsp_flag[ h ][ k ][ m ]
layer_in_bsp_flag[ h ][ i ][ j ] specifies that the layer with index LayerSetLayerIdList[ h ][ j ] is
a part of bitstream partition with index i within the layer set with index h. When not present, the
value of layer_in_bsp_flag[ h ][ i ][ j ] is inferred to be equal to 0.
It is a requirement of bitstream conformance that bitstream partition with index j shall not
include direct or indirect reference layers of any layers in bitstream partition i for any values of i
and j in the range of 0 to num_bitstream_partitions[ h ] − 1, inclusive, such that i is less than j.
It is a requirement of bitstream conformance that, when vps_base_layer_internal_flag is equal to
0 and layer_in_bsp_flag[ h ][ i ][ 0 ] is equal to 1 for any value of h in the range of 1 to
vps_num_layer_sets_minus1, inclusive, and any value of i in the range of 0 to
num_bitstream_partitions[ h ] − 1, inclusive, the value of layer_in_bsp_flag[ h ][ i ][ j ] for at
least one value of j in the range of 1 to NumLayersInIdList[ h ] − 1, inclusive, shall be equal to 1.

In a second option, the fifth bitstream constraint may disallow including the same layer in a layer set in more than one bitstream partition of that layer set when signaling bitstream partition information in VPS VUI bitstream partition HRD parameter semantics. Listing (5) provides an example of the parameter semantics in accordance with the second option:

Listing (5)

It is a requirement of bitstream conformance that bitstream partition
with index j shall not include direct or indirect reference layers of any
layers in bitstream partition i for any values of i and j in the range of 0 to
num_bitstream_partitions[ h ] − 1, inclusive, such that i is less than j.
It is a requirement of bitstream conformance that bitstream partition with
index j shall not include any layer which belongs to bitstream partition i,
with i not equal to j, for any values of i and j in the range of 0 to
num_bitstream_partitions[ h ] − 1, inclusive.

In another configuration, the last paragraph of Listing (5) may instead be given as follows in Listing (6):

Listing (6)

It is a requirement of bitstream conformance that, for any value of h in
the range 1 to vps_num_layer_set_minus1, inclusive, the value of
layer_in_bsp_flag[ h ][ i ][ j ] shall be equal to 1 for only one value
of i in the range 0 to num_bitstream_partitions[ h ]−1, inclusive.

In another configuration, the last paragraph of Listing (6) may instead be given as follows in Listing (6A):

Listing (6A)

It is a requirement of bitstream conformance that, for any value of h
in the range 1 to vps_num_layer_set_minus1, inclusive, the value of
layer_in_bsp_flag[ h ][ i ][ j ] shall be equal to 1 for at most one
value of i in the range 0 to num_bitstream_partitions[ h ]−1, inclusive.

In yet another configuration, the last paragraph of Listing (5) may instead be given as follows in Listing (7):

Listing (7)

It is a requirement of bitstream conformance that, for any value of h
in the range 1 to vps_num_layer_set_minus1, inclusive, the sum of
values of layer_in_bsp_flag[ h ][ i ][ j ] for i in the range 0 to
num_bitstream_partitions[ h ]−1, inclusive, shall be less than or
equal to 1.

In known approaches for signaling bitstream partition specific HRD parameters in the bitstream partition HRD parameters SEI message, it is possible to include a layer in a layer set in multiple bitstream partitions. This may result in lower efficiency in coding and resource usage. Also, the HRD parameters signaled for partitions in this case may require strict checks to make sure that they are correct. Accordingly, it may not be beneficial to perform partitioning in this manner. For example, if this known approach is allowed, duplicate partitions could be signaled. The systems and methods disclosed herein provide options to accomplish the fifth bitstream constraint. A first option may be beneficial by reducing the number of signaling bits in comparison to a known signaling approach.

In one example of the first option, signaling in bsp_hrd( ) may be modified to disallow including the same layer in a layer set in more than one bitstream partition of that layer set. Syntax Table (7) provides one example of a bsp_hrd( ) message structure (from section F.14.1.5 (Bitstream partition HRD parameters SEI message syntax) of JCTVC-P1008v4). However, syntax Table (7) illustrates one example of an implementation of the fifth bitstream constraint. In particular, the syntax “for(k=0, SEILayerIdPrevIncluded[lsIdx][j]=0; k<i; k++),” “SEILayerIdPrevIncluded[lsIdx][j]=SEILayerIdPrevIncluded[lsIdx][j]|sei_layer_in_bsp_flag[lsIdx][k][j]” and “if(layer_id_included_flag[lsIdx][j]] && !SEILayerIdPrevIncluded[lsIdx][j])” may be utilized to implement the fifth bitstream constraint.

TABLE (7)

| bsp_hrd( payloadSize ) { | Descriptor |
|---|---|
| sei_num_bsp_hrd_parameters_minus1 | ue(v) |
| for( i = 0; i <= sei_num_bsp_hrd_parameters_minus1; i++ ) { | |
| if(i > 0) | |
| sei_bsp_cprms_present_flag[ i ] | u(1) |
| hrd_parameters( sei_bsp_cprms_present_flag[ i ], | |
| nesting_max_temporal_id_plus1[ 0 ] − 1 ) | |
| } | |
| for( h=0; h <= nesting_num_ops_minus1; h++ ) { | |
| lsIdx = nesting_op_idx[ h ] | |
| num_sei_bitstream_partitions_minus1[ lsIdx ] | ue(v) |
| for( i = 0; i <= num_sei_bitstream_partitions_minus1[ lsIdx ]; i++ ) | |
| for( j = 0; j <= vps_max_layers_minus1; j++ ) | |
| for( k=0, SEILayerIdPrevIncluded[ lsIdx ][ j ]=0; k < i; k++) | |
| SEILayerIdPrevIncluded[ lsIdx ][ j ]= | |
| SEILayerIdPrevIncluded[ lsIdx ][ j ] \| sei_layer_in_bsp_flag[ lsIdx ][ k ][ j ] | |
| if( layer_id_included_flag[ lsIdx ][ j ] ] | |
| && !SEILayerIdPrevIncluded[ lsIdx ][ j ] ) | |
| sei_layer_in_bsp_flag[ lsIdx ][ i ][ j ] | u(1) |
| sei_num_bsp_sched_combinations_minus1[ lsIdx ] | ue(v) |
| for( i = 0; i <= sei_num_bsp_sched_combinations_minus1[ lsIdx ]; | |
| i++ ) | |
| for( j = 0; j <= num_sei_bitstream_partitions_minus1[ lsIdx ]; | |
| j++ ) { | |
| sei_bsp_comb_hrd_idx[ lsIdx ][ i ][ j ] | ue(v) |
| sei_bsp_comb_sehed_idx[ lsIdx ][ i ][ j ] | ue(v) |
| } | |
| } | |
| } | |

In Table (7), SEILayerIdPrevIncluded is a variable that keeps track of whether a particular layer is already included in one of the partitions of the layer set.

One variant of SEILayerIdPrevIncluded may be defined in bitstream partition HRD parameters SEI message semantics in Listing (8) (which may be applied to section F.14.2.5 of JCTVC-P1008v4 (Bitstream partition HRD parameters SEI message semantics), for example):

For each i in the range of 0 to num_sei_bitstream_partitions_minus1[h], inclusive, for each j in the range of 0 to vps_max_layers_minus1, inclusive, the variable LayerIdPrevIncluded is derived as follows:

Listing (8)

for( k=0, SEILayerIdPrevIncluded[ lsIdx ][ j ]=0; k < i; k++)
{
SEILayerIdPrevIncluded[ lsIdx ][ j ]= SEILayerIdPrevIncluded
[ lsIdx ][ j ] | sei_layer_in_bsp_flag[ lsIdx ][ k ][ j ]
}
sei_layer_in_bsp_flag[ lsIdx ][ i ][ j ] specifies that the layer with index
j is a part of bitstream partition with index i within the layer set with
index lsIdx.
It is a requirement of bitstream conformance that the bitstream partition
with index j should not include direct or indirect reference layers of any
layers in the bitstream partition with index i for any values of i and j in
the range of 0 to num_sei_bitstream_partitions_minus1[ lsIdx ],
inclusive, such that i is less than j.

In a another variant of the fifth bitstream constraint, the index lsIdx may be replaced with the index h in some cases as provided in Listing (9):

Listing (9)

For each i in the range of 0 to num_sei_bitstream_partitions_minus1
[ h ], inclusive, for each j in the range of 0 to vps_max_layers_minus1,
inclusive, the variable SEILayerIdPrevIncluded is derived as follows:
for( k=0, SEILayerIdPrevIncluded[ h ][ j ]=0; k < i; k++)
{
SEILayerIdPrevIncluded[ h ][ j ]= SEILayerIdPrevIncluded[ h ][ j ] |
sei_layer_in_bsp_flag[ h ][ k ][ j ]
}

Some configurations of the systems and methods disclosed herein may operate in accordance with the following description. This may separate one aspect given in Table (9) below and may include it as a stand-alone modification of SHVC standards (with or without one or more of the bitstream constraints, for example). In some configurations, the following changes (illustrated in Table (8) and Listing (10)) may be made to JCTVC-P1008v4 section F.14.1.5 (Bitstream partition HRD parameters SEI message syntax) and F.14.2.5 (Bitstream partition SEI message semantics). Some of the changes are indicated with strikethrough.

TABLE (8)

| bsp_hrd( payloadSize ) { | Descriptor |
|---|---|
| sei_num_bsp_hrd_parameters_minus1 | ue(v) |
| for( i = 0; i <= sei_num_bsp_hrd_parameters_minus1; i++ ) { | |
| if( i > 0 ) | |
| sei_bsp_cprms_present_flag[ i ] | u(1) |
| hrd_parameters( sei_bsp_cprms_present_flag[ i ], | |
| nesting_max_temporal_id_plus1[ 0 ] − 1) | |
| } | |
| for( h=0; h <= nesting_num_ops_minus1; h++ ) { | |
| lsIdx = nesting_op_idx[ h ] | |
| num_sei_bitstream_partitions_minus1[ lsIdx ] | ue(v) |
| for( i = 0; i <= num_sei_bitstream_partitions_minus1[ lsIdx ]; i++) | |
| for( j = 0; j [symbol] NumLayerInIdList[ lsIdx ]; j++ ) | |
| [symbol] | |
| sei_layer_in_bsp_flag[ lsIdx ][ i ][ j ] | u(1) |
| sei_num_bsp_sched_combinations_minus1[ lsIdx ] | ue(v) |
| for( i = 0; i <= sei_num_bsp_sched_combinations_minus1[ lsIdx ]; i++ ) | |
| for( j = 0; j <= sei_num_sei_bitstream_partitions_minus1[ lsIdx ]; j++ ) { | |
| sei_bsp_comb_hrd_idx[ lsIdx ][ i ][ j ] | ue(v) |
| sei_bsp_comb_sched_idx[ lsIdx ][ i ][ j ] | ue(v) |
| } | |
| } | |
| } | |

Listing (10)

sei_layer_in_bsp_flag[ lsIdx ][ i ][ j ] specifies that the layer with index j
LayerSetLayerIdList[ lsIdx ][ j ] is a part of bitstream partition with index i within the layer set
with index lsIdx. When not present, the value of sei_layer_in_bsp_flag[ h ][ i ][ j ] is inferred to
be equal to 0.
It is a requirement of bitstream conformance that the bitstream partition with index j shall not
include direct or indirect reference layers of any layers in the bitstream partition with index i for
any values of i and j in the range of 0 to num_sei_bitstream_partitions_minus1[ lsIdx ], inclusive,
such that i is less than j.
It is a requirement of bitstream conformance that, when vps_base_layer_internal_flag is equal to
0 and sei_layer_in_bsp_flag[ lsIdx ][ i ][ 0 ] is equal to 1 for any value of h in the range of 0 to
nesting_num_ops_minus1, inclusive, and any value of i in the range of 0 to
num_sei_bitstream_partitions_minus1[ lsIdx ] , inclusive, the value of
sei_layer_in_bsp_flag[ lsIdx ][ i ][ j ] for at least one value of j in the range of 1 to
NumLayersInIdList[ lsIdx ] − 1, inclusive, shall be equal to 1.

Another variant of the fifth bitstream constraint is described as follows. Syntax Table (9) provides another example of a bsp_hrd( ) message structure (from section F.14.1.5 (Bitstream partition HRD parameters SEI message syntax) of JCTVC-P1008v4). Some changes are indicated with strikethrough. However, syntax Table (9) illustrates another example of an implementation of the fifth bitstream constraint. In particular, the syntax “for(j=0; j<=NumLayerInIdList[lsIdx]; j++),” “for(k=0, SEILayerIdPrevIncluded[lsIdx][j]=0; k<i; k++),” “SEILayerIdPrevIncluded[lsIdx][j]=SEILayerIdPrevIncluded[lsIdx][j]|sei_layer_in_bsp_flag[lsIdx][k][j]” and “if(!SEILayerIdPrevIncluded[lsIdx][j]),” may be utilized to implement the fifth bitstream constraint.

TABLE (9)

| bsp_hrd( payloadSize ) { | Descriptor |
|---|---|
| sei_num_bsp_hrd_parameters_minus1 | ue(v) |
| for( i = 0; i <= sei_num_bsp_hrd_parameters_minus1; i++ ) { | |
| if(i > 0) | |
| sei_bsp_cprms_present_flag[ i ] | u(1) |
| hrd_parameters( sei_bsp_cprms_present_flag[ i ], | |
| nesting_max_temporal_id_plus1[ 0 ] − 1 ) | |
| } | |
| for( h=0; h <= nesting_num_ops_minus1; h++ ) { | |
| lsIdx = nesting_op_idx[ h ] | |
| num_sei_bitstream_partitions_minus1[ lsIdx ] | ue(v) |
| for( i = 0; i <= num_sei_bitstream_partitions_minus1[ lsIdx ]; i++ ) | |
| for( j = 0; j < NumLayerInIdList[ lsIdx ] [symbol] | |
| j++ ) | |
| for( k=0, SEILayerIdPrevIncluded[ lsIdx ][ j ]=0; k < i; k++) | |
| SEILayerIdPrevIncluded[ lsIdx ][ j ]= | |
| SEILayerIdPrevIncluded[ lsIdx ][ j ] \| sei_layer_in_bsp_flag[ lsIdx ][ k ][ j ] | |
| if(!SEILayerIdPrevIncluded[ lsIdx ][ j ]) | |
| sei_layer_in_bsp_flag[ lsIdx ][ i ][ j ] | u(1) |
| sei_num_bsp_sehed_combinations_minus1[ lsIdx ] | ue(v) |
| for( i = 0; i <= sei_num_bsp_sched_combinations_minus1[ lsIdx ]; | |
| i++ ) | |
| for( j = 0;j <= num_sei_bitstream_partitions_minus1[ lsIdx ]; | |
| j++ ) { | |
| sei_bsp_comb_hrd_idx[ lsIdx ][ i ][ j ] | ue(v) |
| sei_bsp_comb_sehed_idx[ lsIdx ][ i ][ j ] | ue(v) |
| } | |
| } | |
| } | |

Another variant of SEILayerIdPrevIncluded may be defined in bitstream partition HRD parameters SEI message semantics in Listing (11) (which may be applied to section F.14.2.5 of JCTVC-P1008v4 (Bitstream partition HRD parameters SEI message semantics), for example):

Listing (11)

For each i in the range of 0 to num_sei_bitstream_partitions_minus1[ h ]−1, inclusive, for each j
in the range of 0 to vps_max_layers_minus1, inclusive, the variable SEILayerIdPrevIncluded is
derived as follows:
for( k=0, SEILayerIdPrevIncluded[ lsIdx ][ j ]=0; k < i; k++)
SEILayerIdPrevIncluded[ lsIdx ][ j ]= SEILayerIdPrevIncluded[ lsIdx ][ j ]|
sei_layer_in_bsp_flag[ lsIdx ][ k ][ m ]
sei_layer_in_bsp_flag[ lsIdx ][ i ][ j ] specifies that the layer with index
LayerSetLayerIdList[ lsIdx ][ j ] is a part of bitstream partition with index i within the layer set
with index lsIdx. When not present, the value of sei_layer_in_bsp_flag[ h ][ i ][ j ] is inferred to
be equal to 0.
It is a requirement of bitstream conformance that the bitstream partition with index j shall not
include direct or indirect reference layers of any layers in the bitstream partition with index i for
any values of i and j in the range of 0 to num_sei_bitstream_partitions_minus1[ lsIdx ], inclusive,
such that i is less than j.
It is a requirement of bitstream conformance that, when vps_base_layer_internal_flag is equal to
0 and sei_layer_in_bsp_flag[ lsIdx ][ i ][ 0 ] is equal to 1 for any value of h in the range of 0 to
nesting_num_ops_minus1, inclusive, and any value of i in the range of 0 to
num_sei_bitstream_partitions_minus1[ lsIdx ], inclusive, the value of
sei_layer_in_bsp_flag[ lsIdx ][ i ][ j ] for at least one value of j in the range of 1 to
NumLayersInIdList[ lsIdx ] − 1, inclusive, shall be equal to 1.

In another variant of the fifth bitstream constraint, the index lsIdx may be replaced with the index h in some cases as provided in Listing (12):

Listing (12)

For each i in the range of 0 to
num_sei_bitstream_partitions_minus1[ h ]−1, inclusive, for each j in
the range of 0 to NumLayersInIdList[ lsIdx ] − 1, inclusive, the variable
SEILayerIdPrevIncluded is derived as follows:
for( k=0, SEILayerIdPrevIncluded[ h ][ j ]=0; k < i; k++)
{
SEILayerIdPrevIncluded[ h ][ j ]= SEILayerIdPrevIncluded[ h ][ j ] |
sei_layer_in_bsp_flag[ h ][ k ][ j ]
}

Another variant of the fifth bitstream constraint is described as follows. Syntax Table (10) provides another example of a bsp_hrd( ) message structure (from section F.14.1.5 (Bitstream partition HRD parameters SEI message syntax) of JCTVC-P1008v4). Some changes are indicated in strikethrough. However, syntax Table (10) illustrates another example of an implementation of the fifth bitstream constraint. In particular, the syntax “for(j=0; j<NumLayerInIdList[lsIdx]; j++),” “lIdx=LayerSetLayerIdList[lsIdx][j],” “for(k=0, SEILayerIdPrevIncluded[lsIdx][j]=0; k<i; k++),” “for(m=0; m<NumLayersInIdList[h]; m++),” “if(lIdx==SEILayerSetLayerIdList[h][m],” “SEILayerIdPrevIncluded[lsIdx][j]=SEILayerIdPrevIncluded[lsIdx][j]|sei_layer_in_bsp_flag[lsIdx][k][m]” and “if(!SEILayerIdPrevIncluded[lsIdx][j])” may be utilized to implement the fifth bitstream constraint.

TABLE (10)

| bsp_hrd( payloadSize ) { | Descriptor |
|---|---|
| sei_num_bsp_hrd_parameters_minus1 | ue(v) |
| for( i = 0; i <= sei_num_bsp_hrd_parameters_minus1; i++ ) { | |
| if(i > 0) | |
| sei_bsp_cprms_present_flag[ i ] | u(1) |
| hrd_parameters( sei_bsp_cprms_present_flag[ i ], | |
| nesting_max_temporal_id_plus1[ 0 ] − 1) | |
| } | |
| for( h=0; h <= nesting_num_ops_minus1; h++ ) { | |
| lsIdx = nesting_op_idx[ h ] | |
| num_sei_bitstream_partitions_minus1[ lsIdx ] | ue(v) |
| for( i = 0; i <= num_sei_bitstream_partitions_minus1[ lsIdx ]; i++ ) | |
| for( j = 0; j < NumLayerInIdList[ lsIdx [symbol] [symbol] [symbol] | |
| j++ ) | |
| lIdx= LayerSetLayerIdList[ lsIdx ][ j ]; | |
| P11 for( k=0, SEILayerIdPrevIncluded[ lsIdx ][ j ]=0; k < i; k++) | |
| for( m=0; m < NumLayersInIdList[ h ]; m++) | |
| if(lIdx== SEILayerSetLayerIdList[ h ][ m ] | |
| SEILayerIdPrevIncluded[ lsIdx ][ j ]= | |
| SEILayerIdPrevIncluded[ lsIdx ][ j ] \| | |
| sei_layer_in_bsp_flag[ lsIdx ][ k ][ m ] | |
| if(!SEILayerIdPrevIncluded[ lsIdx ][ j ]) | |
| sei_layer_in_bsp_flag[ lsIdx ][ i ][ j ] | u(1) |
| sei_num_bsp_sched_combinations_minus1[ lsIdx ] | ue(v) |
| for( i = 0; i <= sei_num_bsp_sched_combinations_minus1[ lsIdx ]; | |
| i++ ) | |
| for( j = 0; j <= num_sei_bitstream_partitions_minus1[ lsIdx ]; | |
| j++ ) { | |
| sei_bsp_comb_hrd_idx[ lsIdx ][ i ][ j ] | ue(v) |
| sei_bsp_comb_sched_idx[ lsIdx ][ i ][ j ] | ue(v) |
| } | |
| } | |
| } | |

In Table (10), SEILayerSetLayerIdList is a variable that keeps track of whether a particular layer is already included in one of the partitions of the layer set.

Another variant of SEILayerIdPrevIncluded may be defined in bitstream partition HRD parameters SEI message semantics in Listing (13) (which may be applied to section F.14.2.5 of JCTVC-P1008v4 (Bitstream partition HRD parameters SEI message semantics), for example):

Listing (13)

```
For each i in the range of 0 to num_sei_bitstream_partitions_minus1[ h ], inclusive, for each j in
the range of 0 to vps_max_layers_minus1, inclusive The variable SEILayerIdPrevIncluded is
derived as follows:
lIdx= LayerSetLayerIdList[ lsIdx ][ j ];
for( k=0, SEILayerIdPrevIncluded[ lsIdx ][ j ]=0; k < i; k++)
    for( m=0; m < NumLayersInIdList[ h ]; m++)
        if(lIdx== SEILayerSetLayerIdList[ h ][ m ]
        SEILayerIdPrevIncluded[ lsIdx ][ j ]= SEILayerIdPrevIncluded[ lsIdx ][ j ] |
sei_layer_in_bsp_flag[ lsIdx ][ k ][ m ]
sei_layer_in_bsp_flag[ lsIdx ][ i ][ j ] specifies that the layer with index
LayerSetLayerIdList[ lsIdx ][ j ] is a part of bitstream partition with index i within the layer set
with index lsIdx. When not present, the value of sei_layer_in_bsp_flag[ h ][ i ][ j ] is inferred to
be equal to 0.
It is a requirement of bitstream conformance that the bitstream partition with index j shall not
include direct or indirect reference layers of any layers in the bitstream partition with index i for
any values of i and j in the range of 0 to num_sei_bitstream_partitions_minus1[ lsIdx ], inclusive,
such that i is less than j.
It is a requirement of bitstream conformance that, when vps_base_layer_internal_flag is equal to
0 and sei_layer_in_bsp_flag[ IsIdx ][ i ][ 0 ] is equal to 1 for any value of h in the range of 0 to
nesting_num_ops_minus1, inclusive, and any value of i in the range of 0 to
num_sei_bitstream_partitions_minus1[ lsIdx ], inclusive, the value of
sei_layer_in_bsp_flag[ lsIdx ][ i ][ j ] for at least one value of j in the range of 1 to
NumLayersInIdList[ lsIdx ] − 1, inclusive, shall be equal to 1.
```

In a another variant of the fifth bitstream constraint, the index lsIdx may be replaced with the index h in some cases as provided in Listing (14):

Listing (14)

For each i in the range of 0 to num_sei_bitstream_partitions_minus1
[ h ], inclusive, for each j in the range of 0 to
NumLayersInIdList[lsIdx] −1, inclusive, the variable
SEILayerIdPrevIncluded is derived as follows:
for( k=0, SEILayerIdPrevIncluded[ h ][ j ]=0; k < i; k++)
{
SEILayerIdPrevIncluded[ h ][ j ]= SEILayerIdPrevIncluded[ h ][ j ] |
sei_layer_in_bsp_flag[ h ][ k ][ j ]
}

In a second option, the fifth bitstream constraint may disallow including the same layer in a layer set in more than one bitstream partition of that layer set when signaling bitstream partition information in bitstream partition HRD parameter SEI message semantics. Listing (15) provides an example of the parameter semantics in accordance with the second option:

Listing (15)

It is a requirement of bitstream conformance that the bitstream partition
with index j shall not include direct or indirect reference layers of any
layers in the bitstream partition with index i for any values of i and j
in the range of 0 to num_sei_bitstream_partitions_minus1[ lsIdx ],
inclusive, such that i is less than j.
It is a requirement of bitstream conformance that bitstream partition with
index j shall not include any layer which belongs to bitstream partition i,
with i not equal to j, for any values of i and j in the range of 0 to
num_sei_bitstream_partitions_minus1, inclusive.

In another configuration, the last paragraph of Listing (15) may instead be given as follows in Listing (16):

Listing (16)

It is a requirement of bitstream conformance that, for any value of h in the
range 0 to nesting_num_ops_minus1, inclusive, the value of
sei_layer_in_bsp_flag[ lsIdx ][ i ][ j ] shall be equal to 1 for only
one value of i in the range 0 to
num_sei_bitstream_partitions_minus1[ lsIdx ], inclusive.

In another configuration, the last paragraph of Listing (16) may instead be given as follows in Listing (16A):

Listing (16A)

It is a requirement of bitstream conformance that, for any value of h in
the range 0 to nesting_num_ops_minus1, inclusive, the value of
sei_layer_in_bsp_flag[ lsIdx ][ i ][ j ] shall be equal to 1 for at most
one value of i in the range 0 to
num_sei_bitstream_partitions_minus1[ lsIdx ], inclusive.

In yet another configuration, the last paragraph of Listing (15) may instead be given as follows in Listing (17):

Listing (17)

It is a requirement of bitstream conformance that, for any value of h in
the range 1 to nesting_num_ops_minus1, inclusive, the sum of values of
sei_layer_in_bsp_flag[ lsIdx ][ i ][ j ] for i in the range 0 to
num_sei_bitstream_partitions_minus1[ lsIdx ], inclusive, shall be
less than or equal to 1.

A sixth bitstream constraint is described as follows. Bitstream constraining module A 108a may constrain the bitstream 110 such that each bitstream partition of a layer set is distinct from any other bitstream partition of the layer set. This may be a requirement for bitstream conformance. If this bitstream constraint condition is not met, bitstream constraining module A 108a may perform one or more of not allowing the bitstream partition to be specified, removing one or more duplicate bitstream partitions' information (from the bitstream 110), removing overhead information corresponding to the one or more duplicate bitstream partitions and generating a sixth indicator. The sixth indicator may indicate bitstream non-compliance.

In particular, each bitstream partition of a layer set must be distinct (e.g., two or more bitstream partitions of a layer set cannot be identical). For example, a bitstream partition signaled in a VPS VUI bitstream partition HRD parameters message structure (e.g., vps_vui_bsp_hrd_parameters( )) for a layer set cannot exactly match another bitstream partition for the same layer set. It may be wasteful to signal the same bitstream partition for a layer set more than once.

More specifically, for any value of h in the range of 1 to vps_num_layer_set_minus1, inclusive, the value of layer_in_bsp_flag[h][k][j] should not be equal to the value of layer_in_bsp_flag[h][p][j] for at least one value of j in the range of 0 to vps_max_layers_minus1, inclusive, with k not equal to p, and for any value of k in the range of 0 to num_bitstream_partitions[h]−1, inclusive, and for any value of p in the range of 0 to num_bitstream_partitions[h]−1, inclusive. This may be a requirement for bitstream conformance.

One variant of the sixth bitstream constraint (based on JCTVC-P0184v4) is described as follows. For any value of h in the range of 1 to vps_num_layer_set_minus1, inclusive, the value of layer_in_bsp_flag[h][k][j] should not be equal to the value of layer_in_bsp_flag[h][p][m] with k not equal to p, with LayerSetLayerIdList[h][j] equal to LayerSetLayerIdList[h][m], and for any value of k in the range of 0 to num_bitstream_partitions[h]−1, inclusive, and for any value of p in the range of 0 to num_bitstream_partitions[h]−1, inclusive. This may be a requirement for bitstream conformance.

One variant of the sixth bitstream constraint is described as follows. For any value of h in the range of 1 to vps_num_layer_set_minus1, inclusive, the value of layer_in_bsp_flag[h][k][j] should not be equal to the value of layer_in_bsp_flag[h][p][j] for at least one value of j in the range of 0 to NumLayersInIdList[h]−1, inclusive, with k not equal to p, for any value of k in the range of 0 to num_bitstream_partitions[h]−1, inclusive, and for any value of p in the range of 0 to num_bitstream_partitions[h]−1, inclusive. This may be a requirement for bitstream conformance.

One variant of the sixth bitstream constraint is described as follows. For any value of h in the range of 1 to vps_num_layer_set_minus1, inclusive, the value of layer_in_bsp_flag[h][k][j] should not be equal to the value of layer_in_bsp_flag[h][p][j] for at least one value of j in the range of 0 to NumLayersInIdList[h]−1, inclusive, with k not equal to p, for any value of k and p in the range of 0 to num_bitstream_partitions[h]−1, inclusive. This may be a requirement for bitstream conformance.

One variant of the sixth bitstream constraint is described as follows. For any value of h in the range of 1 to vps_num_layer_set_minus1, inclusive, the value of layer_in_bsp_flag[h][k][j] should not be equal to the value of layer_in_bsp_flag[h][p][m] for at least one value of j and m in the range of 0 to NumLayersInIdList[h]−1, inclusive, with k not equal to p, with LayerSetLayerIdList[h][j] equal to LayerSetLayerIdList[h][m], and for any value of k in the range of 0 to num_bitstream_partitions[h]−1, inclusive, and for any value of p in the range of 0 to num_bitstream_partitions[h]−1, inclusive. This may be a requirement for bitstream conformance.

Another configuration of the sixth bitstream constraint is described as follows. In particular, each bitstream partition of a layer set must be distinct (e.g., two or more bitstream partitions of a layer set cannot be identical). For example, a bitstream partition signaled in a bitstream partition HRD parameters SEI message structure (e.g., bsp_hrd( )) for a layer set cannot exactly match another bitstream partition for the same layer set. It may be wasteful to signal the same bitstream partition for a layer set more than once.

More specifically, for any value of h in the range of 0 to nesting_num_ops_minus1, inclusive, the value of sei_layer_in_bsp_flag[lsIdx][k][j] should not be equal to the value of sei_layer_in_bsp_flag[lsIdx][p][j] for at least one value of j in the range of 0 to vps_max_layers_minus1, inclusive, with k not equal to p and for any value of k in the range of 0 to num_sei_bitstream_partitions_minus1[lsIdx], inclusive, and for any value of p in the range of 0 to num_sei_bitstream_partitions_minus1[lsIdx], inclusive. This may be a requirement for bitstream conformance.

Another variant of the sixth bitstream constraint (based on JCTVC-P0184v4) is described as follows. For any value of h in the range of 0 to nesting_num_ops_minus1, inclusive, the value of sei_layer_in_bsp_flag[lsIdx][k][j] should not be equal to the value of sei_layer_in_bsp_flag[lsIdx][p][m] with k not equal to p, with LayerSetLayerIdList[lsIdx][j] equal to LayerSetLayerIdList[lsIdx][m], and for any value of k in the range of 0 to num_sei_bitstream_partitions_minus1[lsIdx], inclusive, and for any value of p in the range of 0 to num_sei_bitstream_partitions_minus1[lsIdx], inclusive. This may be a requirement for bitstream conformance.

Another variant of the sixth bitstream constraint is described as follows. For any value of h in the range of 0 to nesting_num_ops_minus1, inclusive, the value of sei_layer_in_bsp_flag[lsIdx][k][j] should not be equal to the value of sei_layer_in_bsp_flag[lsIdx][p][j] for at least one value of j in the range of 0 to NumLayersInIdList[lsIdx]−1, inclusive, with k not equal to p, for any value of k in the range of 0 to num_sei_bitstream_partitions_minus1[lsIdx], inclusive, and for any value of p in the range of 0 to num_sei_bitstream_partitions_minus1[lsIdx], inclusive. This may be a requirement for bitstream conformance.

Another variant of the sixth bitstream constraint is described as follows. For any value of h in the range of 0 to nesting_num_ops_minus1, inclusive, the value of sei_layer_in_bsp_flag[lsIdx][k][j] should not be equal to the value of sei_layer_in_bsp_flag[lsIdx][p][j] for at least one value of j in the range of 0 to NumLayersInIdList[lsIdx]−1, inclusive, with k not equal to p, for any value of k and p in the range of 0 to num_sei_bitstream_partitions_minus1[lsIdx], inclusive. This may be a requirement for bitstream conformance.

Another variant of the sixth bitstream constraint is described as follows. For any value of h in the range of 0 to nesting_num_ops_minus1, inclusive, the value of sei_layer_in_bsp_flag[lsIdx][k][j] should not be equal to the value of sei_layer_in_bsp_flag[lsIdx][p][m] for at least one value of j and m in the range of 0 to NumLayersInIdList[lsIdx]−1, inclusive, with k not equal to p, with LayerSetLayerIdList[lsIdx][j] equal to LayerSetLayerIdList[lsIdx][m], and for any value of k in the range of 0 to num_sei_bitstream_partitions_minus1[lsIdx], inclusive, and for any value of p in the range of 0 to num_sei_bitstream_partitions_minus1[lsIdx], inclusive. This may be a requirement for bitstream conformance.

In some configurations, one or more of the syntax elements described above may be signaled using a known fixed number of bits instead of u(v) or instead of ue(v). For example, one or more of the syntax elements may be signaled using u(8) or u(16) or u(32) or u(64), etc. Additionally or alternatively, one or more syntax elements may be signaled a fewer or greater number of times than described above. For example, a 1 bit flag value may be shown to be signaled N times. Alternatively, the 1 bit flag value may be signaled M times, where M may be more than N or M may be less than N. Additionally or alternatively, one or more of the syntax elements described above may be signaled with ue(v) or some other coding scheme instead of a fixed number of bits such as u(v) coding. Additionally or alternatively, one or more of the syntax elements described above may be signaled with u(v) or some other coding scheme instead of a coding scheme such as u(v) coding.

In some configurations, the names of various syntax elements and their semantics may be altered by adding a plus 1 or plus2 or by subtracting a minus1 or a minus2 as compared to the described syntax and semantics. Additionally or alternatively, one or more syntax elements may be signaled per picture anywhere in the bitstream 110. For example, one or more syntax elements may be signaled in a slice segment header, PPS, SPS, VPS, any other parameter set or other normative part of the bitstream 110.

It should be noted that any or all the concepts described in accordance with the systems and methods disclosed herein that are related to output layer sets may be additionally or alternatively applied to output operation points and/or to operation points. An operation point may be a bitstream created from another bitstream via sub-bitstream extraction. Sub-bitstream extraction may be based on another bitstream, a target highest TemporalID and a target layer identifier list. It should be noted that any or all the concepts described in accordance with the systems and methods disclosed herein that are related to output layer sets may be additionally or alternatively applied to layer sets.

It should be noted that bitstream module A 108a may implement one or more of the first bitstream constraint, second bitstream constraint, third bitstream constraint, fourth bitstream constraint, fifth bitstream constraint and sixth bitstream constraint, including combinations. Additionally or alternatively, any of the one or more configurations, options, variants, functions, procedures, steps and operations described above may be implemented in accordance with the systems and methods disclosed herein, including combinations (where compatible). It should also be noted that one or more of the configurations, options, variants, functions, procedures, steps and operations described above may be implemented as a method.

The bitstream 110 may be provided to a decoder 112. In one example, the bitstream 110 may be transmitted to electronic device B 102b using a wired or wireless link. In some cases, this may be done over a network, such as the Internet, Local Area Network (LAN) or other type of network for communicating between devices. As illustrated in FIG. 1, the decoder 112 may be implemented on electronic device B 102b separately from the encoder 106 on electronic device A 102a. It should be noted that in some configurations, the encoder 106 and decoder 112 may be implemented on the same electronic device. In an implementation where the encoder 106 and decoder 112 are implemented on the same electronic device, for instance, the bitstream 110 may be made available to the decoder in a variety of ways. For example, the bitstream 110 may be provided over a bus to the decoder 112 or stored in memory for retrieval by the decoder 112.

One or more of the decoder 112 and bitstream constraining module B 108b may be implemented in hardware (e.g., circuitry) or a combination of hardware and software (e.g., a processor with instructions). In one configuration, the decoder 112 may be an HEVC extension (e.g., SHVC, MV-HEVC, etc.) decoder. The decoder 112 may obtain (e.g., receive) the bitstream 110. The decoder 112 may generate one or more decoded pictures 116 based on the bitstream 110. A decoded picture 114 may be displayed, played back, stored in memory and/or transmitted to another device, etc.

In some configurations, the decoder 112 may include bitstream constraining module B 108b. In other configurations, bitstream constraining module B 108b may not be included in the decoder 112. For example, bitstream constraining module B 108b may be included in electronic device B 102b, but may be separate from the decoder 112. In yet other configurations, electronic device B 102b may not include a decoder 112, but may independently include bitstream constraining module B 108b. For example, electronic device B 102b may not include a decoder 112 but may include bitstream constraining module B 108b for checking bitstream conformance. In yet other configurations, electronic device B 102b may not include bitstream constraining module B 108b.

Accordingly, electronic device A 102a may or may not include bitstream constraining module A 108a, which may be included in the encoder 106 or which may be separate from the encoder 106. In some configurations, bitstream constraining module A 108a may not be implemented or utilized. Additionally or alternatively, electronic device B 102b may or may not include bitstream constraining module B 108b, which may be included in the decoder 112 or which may be separate from the decoder 112. In some configurations, bitstream constraining module B 108b may not be implemented or utilized. In other configurations, both electronic device A 102a may include bitstream constraining module A108a and electronic device B 102b may include bitstream constraining module B 108b. It should be noted that some configurations of the systems and methods disclosed herein may only include a single electronic device 102 with a single bitstream constraining module 108.

Bitstream constraining module B 108b may perform one or more of the functions, procedures, steps and operations described in connection with bitstream constraining module A 108a. For example, bitstream module B 108b may implement one or more of the first bitstream constraint, second bitstream constraint, third bitstream constraint, fourth bitstream constraint, fifth bitstream constraint and sixth bitstream constraint described above in connection with bitstream constraining module A 108a, including combinations. In particular, bitstream constraining module B 108b may obtain a bitstream 110 (generated by an encoder 106, for example) may place one or more of the first bitstream constraint, second bitstream constraint, third bitstream constraint, fourth bitstream constraint, fifth bitstream constraint and sixth bitstream constraint described above. Additionally or alternatively, any of the one or more configurations, options, variants, functions, procedures, steps and operations described above may be implemented in accordance with the systems and methods disclosed herein, including combinations (where compatible). It should also be noted that one or more of the configurations, options, variants, functions, procedures, steps and operations described above may be implemented as a method.

In some configurations, electronic device B 102b may output a decoded picture 114. In one example, the decoded picture 114 may be transmitted to another device or back to electronic device A 102a. In one configuration, the decoded picture 114 may be stored or otherwise maintained on electronic device B 102b. In another example, electronic device B 102b may display the decoded picture 114. In other configurations, the decoded picture 114 may include elements of the input picture 104 with different properties based on the encoding and other operations performed on the bitstream 110. In some configurations, the decoded picture 114 may be included in a picture stream with a different resolution, format, specifications or other attribute from the input picture 104.

It should be noted that in some configurations or instances, the bitstream 110 may be provided to electronic device B 102b. For example, the electronic device B 102b may include a decoder 112 that may receive the bitstream 110 sent from electronic device A 102a. Alternatively, the bitstream 110 may be relayed to the electronic device B 102b through an intervening device. For example, the intervening device may receive the bitstream 110 and relay it to electronic device B 102b.

It should also be noted that one or more of the elements or parts thereof included in the electronic device(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application specific integrated circuit (ASIC), a large-scale integrated circuit (LSI) or integrated circuit, etc.

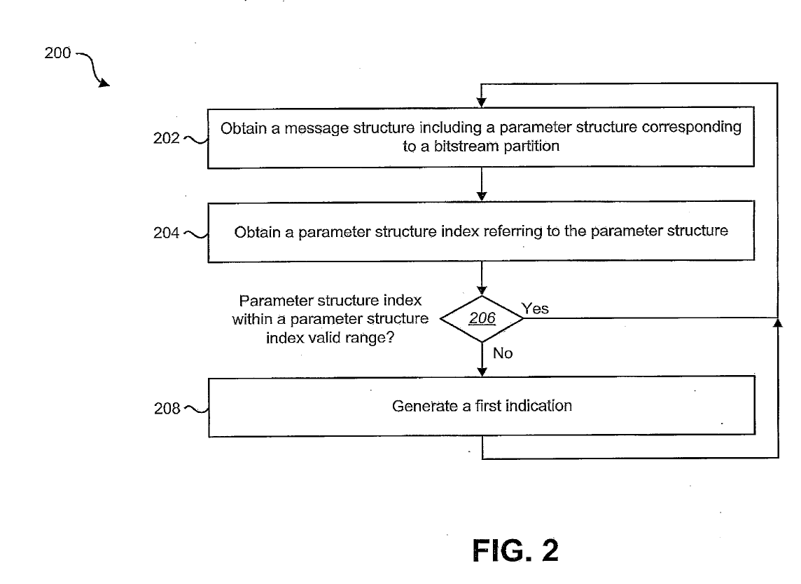

FIG. 2 is a flow diagram illustrating one configuration of a method 200 for constraining a bitstream 110. The method 200 may be performed by one or more of the electronic devices 102a-b described in connection with FIG. 1. The method 200 illustrates one example of constraining a bitstream in accordance with the first bitstream constraint described above.

An electronic device 102 may obtain 202 a message structure (e.g., vps_vui_bsp_hrd_parameters( ), bps_hrd( )) including a parameter structure (e.g., hrd_parameters( )) corresponding to a bitstream partition. This may be accomplished as described above in connection with FIG. 1. For example, the electronic device 102 may encode one or more input pictures 104 to obtain 202 a bitstream 110 that includes the message structure. Additionally or alternatively, the electronic device 102 may receive a bitstream 110 that includes the message structure.

The electronic device 102 may obtain 204 a parameter structure index (e.g., bsp_comb_hrd_idx, sei_bsp_comb_hrd_idx) referring to the parameter structure (e.g., hrd_parameters( )). This may be accomplished as described above in connection with FIG. 1. For example, the electronic device 102 may perform one or more of extracting and reading the parameter structure index from the bitstream 110.

The electronic device 102 may determine 206 whether the parameter structure index is within a parameter structure index valid range. This may be accomplished as described above in connection with FIG. 1. For example, the electronic device 102 may determine 206 whether bsp_comb_hrd_idx is within a range of 0 to vps_num_bsp_hrd_parameters_minus1. Additionally or alternatively, the electronic device 102 may determine 206 whether sei_bsp_comb_hrd_idx is within a range of 0 to sei_num_bsp_hrd_parameters_minus1.

If the parameter structure index is within the parameter structure index valid range, the electronic device 102 may return to obtaining 202 a subsequent message structure. In some configurations, the electronic device 102 may indicate that the parameter structure index was within the parameter structure index valid range.

If the parameter structure index is not within the parameter structure index valid range, the electronic device 102 may generate 208 a first indication. This may be accomplished as described above in connection with FIG. 1. The first indication may indicate that at least one parameter structure has an associated parameter structure index that is outside of the parameter structure index valid range. In some configurations, the first indication may be utilized to do one or more of modify the bitstream 110 (such that no parameter structure index is outside of the parameter structure index valid range, for example), modify encoding procedures and indicate bitstream 110 (e.g., encoder 106) non-conformance.

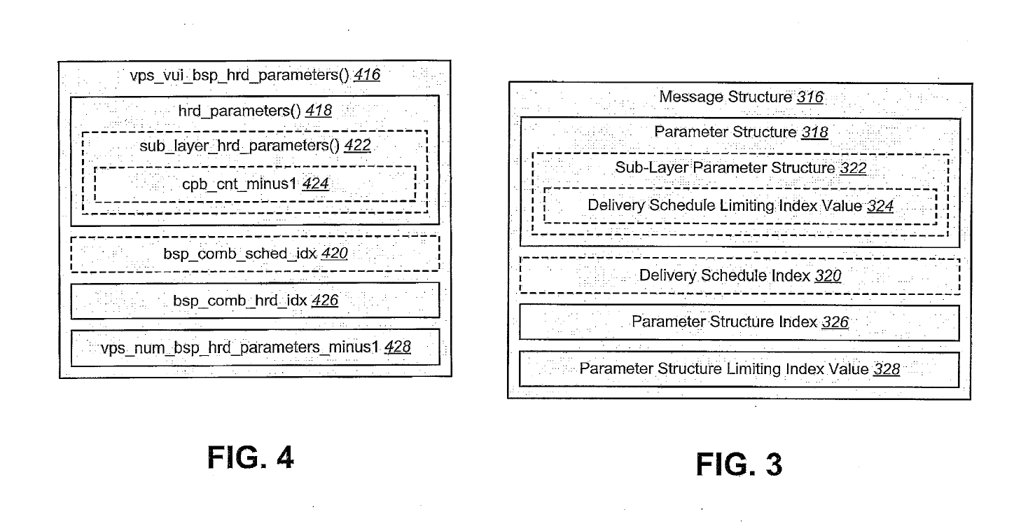

FIG. 3 is a block diagram illustrating one example of a message structure 316 in accordance with the systems and methods disclosed herein. The message structure 316 may be a logical or syntactical structure that is included in a message. The message may include overhead data relating to input picture 104 encoding. The message may be signaled in the bitstream 110. Additionally or alternatively, the message may be signaled within side information. Accordingly, the message structure 316 may be included in one or more of the bitstream 110 and side information. Examples of the message structure include a VPS VUI message structure (e.g., vps_vui_bsp_hrd_parameters( )) and a bitstream partition HRD parameters SEI message structure (e.g., bsp_hrd( )). The message structure 316 (and one or more components of the message structure 316, for example) may be utilized in accordance with one or more of the bitstream constraints described above. For instance, an electronic device 102 may utilize the message structure 316 to implement one or more of the first bitstream constraint, second bitstream constraint, third bitstream constraint, fourth bitstream constraint, fifth bitstream constraint and sixth bitstream constraint described above in connection with FIG. 1.

The message structure 316 may include a parameter structure 318. As described above, the parameter structure 318 may be a logical or syntactical entity that includes one or more parameters. One example of a parameter structure is hrd_parameters( ).

The message structure 316 may optionally include one or more delivery schedule indexes 320. The delivery schedule index 320 may be an index (including index values, for example) associated with delivery schedules. Examples of the delivery schedule index include bsp_comb_sched_idx and sei_bsp_comb_sched_idx.

Additionally or alternatively, the parameter structure 318 may optionally include a sub-layer parameter structure 322. The sub-layer parameter structure 322 may be logical or syntactical entity included within the parameter structure 318 (e.g., hrd_parameters( )). One example of the sub-layer parameter structure 322 may be a sub-layer HRD parameter structure (e.g., sub_layer_hrd_parameters( )).

A delivery schedule limiting index value 324 may be included in the sub-layer parameter structure 322. The delivery schedule limiting index value 324 may be utilized (by the electronic device 102, for example) to establish a delivery schedule index valid range. For example, a delivery schedule index valid range may include a range from 0 to the delivery schedule limiting index value 324. One example of the delivery schedule limiting index value 324 is cpb_cnt_minus1. For instance, the delivery schedule index valid range may include a range from 0 to cpb_cnt_minus1.

One or more parameter structure indexes 326 may be included in the message structure 316. The parameter structure index 326 may be an index (including index values, for example) associated with parameter structures (with an index value associated with the parameter structure 318, for example). Accordingly, each parameter structure 318 may have an index value in the parameter structure index 326 that is associated with the parameter structure 318. Examples of parameter structure indexes 326 include bsp_comb_hrd_idx and sei_bsp_comb_hrd_idx.

A parameter structure limiting index value 328 may be included in the message structure 316. The parameter structure limiting index value 328 may be utilized (by the electronic device 102, for example) to establish a parameter structure index valid range. For example, a parameter structure index valid range may include a range from 0 to the parameter structure limiting index value 328. Examples of parameter structure limiting index values include vps_num_bsp_hrd_parameters_minus1 and sei_num_bsp_hrd_parameters_minus1. For instance, the parameter structure index valid range may include a range from 0 to vps_num_bsp_hrd_parameters_minus1. Additionally or alternatively, the parameter structure index valid range may include a range from 0 to sei_num_bsp_hrd_parameters_minus1.

FIG. 4 is a block diagram illustrating a more specific example of a message structure in accordance with the systems and methods disclosed herein. In this example, the message structure is vps_vui_bsp_hrd_parameters( ) 416. vps_vui_bsp_hrd_parameters( ) 416 may be a logical or syntactical structure that is included in a message. vps_vui_bsp_hrd_parameters( ) 416 (and one or more components of vps_vui_bsp_hrd_parameters( ) 416, for example) may be utilized in accordance with one or more of the bitstream constraints described above. For instance, an electronic device 102 may utilize vps_vui_bsp_hrd_parameters( ) 416 to implement one or more of the first bitstream constraint, second bitstream constraint, third bitstream constraint, fourth bitstream constraint, fifth bitstream constraint and sixth bitstream constraint described above in connection with FIG. 1.

vps_vui_bsp_hrd_parameters( ) 416 may include hrd_parameters( ) 418. As described above, hrd_parameters( ) 418 may be a logical or syntactical entity that includes one or more parameters.

vps_vui_bsp_hrd_parameters( ) 416 may optionally include bsp_comb_sched_idx 420. bsp_comb_sched_idx 420 may be a delivery schedule index (including index values, for example) associated with delivery schedules.

Additionally or alternatively, hrd_parameters( ) 418 may optionally include sub_layer_hrd_parameters( ) 422. sub_layer_hrd_parameters( ) 422 may be a logical or syntactical entity included within hrd_parameters( ) 418.

cpb_cnt_minus1 424 may be included in sub_layer_hrd_parameters( ) 422. cpb_cnt_minus1 424 may be utilized (by the electronic device 102, for example) to establish a delivery schedule index valid range. For example, a delivery schedule index valid range may include a range from 0 to the cpb_cnt_minus1 424.

One or more bsp_comb_hrd_idx 426 may be included in vps_vui_bsp_hrd_parameters( ) 416. bsp_comb_hrd_idx 426 may be an index (including index values, for example) associated with parameter structures. Accordingly, each hrd_parameters( ) 418 structure may have an associated index value in bsp_comb_hrd_idx 426.

vps_num_bsp_hrd_parameters_minus1 428 may be included in vps_vui_bsp_hrd_parameters( ) 416. vps_num_bsp_hrd_parameters_minus1 428 may be utilized (by the electronic device 102, for example) to establish a parameter structure index valid range. For example, a parameter structure index valid range may include a range from 0 to vps_num_bsp_hrd_parameters_minus1 428.

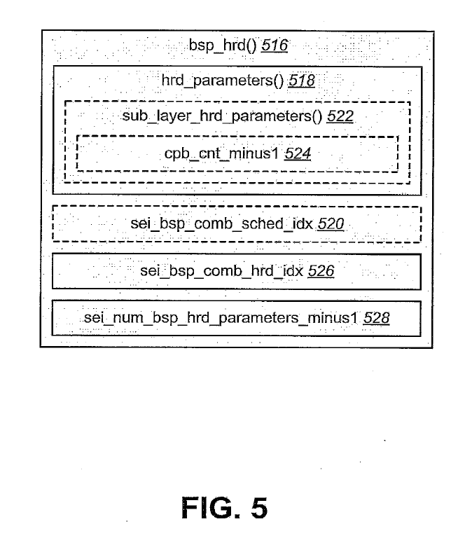

FIG. 5 is a block diagram illustrating another more specific example of a message structure in accordance with the systems and methods disclosed herein. In this example, the message structure is bsp_hrd( ) 516. bsp_hrd( ) 516 may be a logical or syntactical structure that is included in a message. bsp_hrd( ) 516 (and one or more components of bsp_hrd( ) 516, for example) may be utilized in accordance with one or more of the bitstream constraints described above. For instance, an electronic device 102 may utilize bsp_hrd( ) 516 to implement one or more of the first bitstream constraint, second bitstream constraint, third bitstream constraint, fourth bitstream constraint, fifth bitstream constraint and sixth bitstream constraint described above in connection with FIG. 1.

bsp_hrd( ) 516 may include hrd_parameters( ) 518. As described above, hrd_parameters( ) 518 may be a logical or syntactical entity that includes one or more parameters.

bsp_hrd( ) 516 may optionally include sei_bsp_comb_sched_idx 520. sei_bsp_comb_sched_idx 520 may be a delivery schedule index (including index values, for example) associated with delivery schedules.

Additionally or alternatively, hrd_parameters( ) 518 may optionally include sub_layer_hrd_parameters( ) 522. sub_layer_hrd_parameters( ) 522 may be a logical or syntactical entity included within hrd_parameters( ) 518.

cpb_cnt_minus1 524 may be included in sub_layer_hrd_parameters( ) 522. cpb_cnt_minus1 524 may be utilized (by the electronic device 102, for example) to establish a delivery schedule index valid range. For example, a delivery schedule index valid range may include a range from 0 to the cpb_cnt_minus1 524.

One or more sei_bsp_comb_hrd_idx 526 may be included in bsp_hrd( ) 516. sei_bsp_comb_hrd_idx 526 may be an index (including index values, for example) associated with parameter structures. Accordingly, each hrd_parameters( ) 518 structure may have an associated index value in sei_bsp_comb_hrd_idx 526.

sei_num_bsp_hrd_parameters_minus1 528 may be included in bsp_hrd( ) 516. sei_num_bsp_hrd_parameters_minus1 528 may be utilized (by the electronic device 102, for example) to establish a parameter structure index valid range. For example, a parameter structure index valid range may include a range from 0 to sei_num_bsp_hrd_parameters_minus1 528.

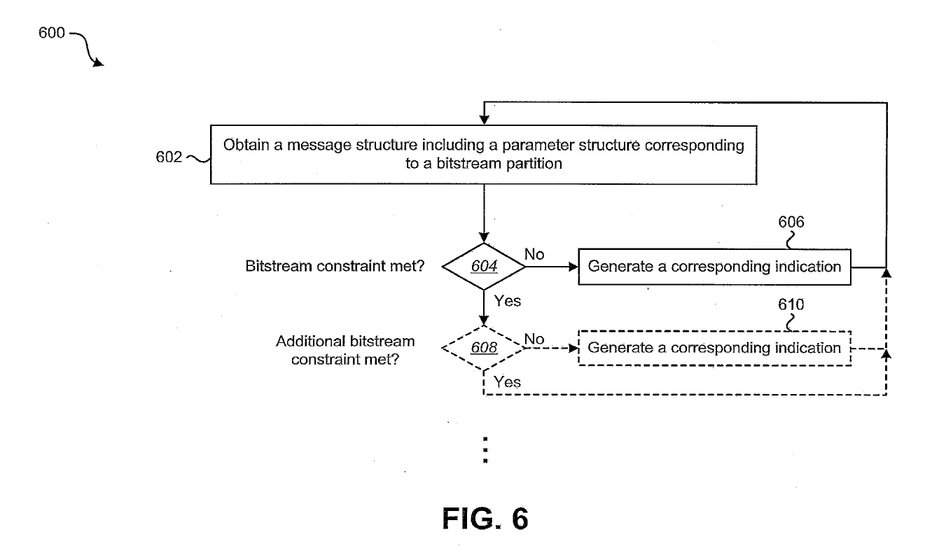

FIG. 6 is a flow diagram illustrating another configuration of a method 600 for constraining a bitstream 110. The method 600 may be performed by one or more of the electronic devices 102a-b described in connection with FIG. 1. The method 600 illustrates constraining a bitstream in accordance with one or more of the bitstream constraints (e.g., one or more of the first bitstream constraint, second bitstream constraint, third bitstream constraint, fourth bitstream constraint, fifth bitstream constraint and sixth bitstream constraint, including combinations) described above.

An electronic device 102 may obtain 602 a message structure (e.g., vps_vui_bsp_hrd_parameters( ), bps_hrd( )) including a parameter structure (e.g., hrd_parameters( )) corresponding to a bitstream partition. This may be accomplished as described above in connection with one or more of FIGS. 1-2.

In some configurations, the electronic device 102 may perform one or more of obtaining and identifying one or more structures or parameters based on the message structure. As described in connection with FIG. 2, for example, the electronic device 102 may obtain a parameter structure index (e.g., bsp_comb_hrd_idx, sei_bsp_comb_hrd_idx) referring to the parameter structure (e.g., hrd_parameters( )) in some configurations.

The electronic device 102 may determine 604 whether a bitstream constraint is met. This may be accomplished as described in connection with one or more of FIGS. 1-2. In particular, the electronic device 102 may determine 604 whether the first bitstream constraint, second bitstream constraint, third bitstream constraint, fourth bitstream constraint, fifth bitstream constraint or sixth bitstream constraint is met. In accordance with the first bitstream constraint, for example, the electronic device 102 may determine 604 whether the parameter structure index is within a parameter structure index valid range. This may be accomplished as described above in connection with one or more of FIGS. 1-2. In other examples, the electronic device 102 may determine 604 whether a delivery schedule index is within a delivery schedule valid range, determine 604 whether a bitstream partition exactly matches a layer set (when only one bitstream partition is signaled for a layer set in the message structure), determine 604 whether parameters in the message structure are signaled for the layer set (in the case of a matching bitstream partition) or whether parameters specific to the bitstream partition match any parameters signaled in the VPS for the layer set (in the case of a matching bitstream partition), determine 604 whether a parameter structure index is coded using a fixed length coding scheme, determine 604 whether any layer in a layer set is included in more than one bitstream partition and determine 604 whether a bitstream partition of a layer set matches any other bitstream partition of the layer set.

If the bitstream constraint is not met, the electronic device 102 may generate 606 a corresponding indication. For example, the generated 606 indication may correspond to the particular bitstream constraint evaluated (e.g., the bitstream constraint that is determined 604 whether or not it is met). The indication may indicate bitstream 110 non-conformance. As described above, the electronic device 102 may perform one or more actions based on the indication. For example, the electronic device 102 may modify the bitstream 110 to bring the bitstream into conformance. This may include removing one or more bitstream partitions and corresponding overhead information (e.g., structures, syntax, signaling, etc.) in some configurations. Additionally or alternatively, the electronic device may perform one or more of displaying the indication, transmitting the indication to another device, logging the indication, storing the indication, printing the indication, etc.

In one example, if the first bitstream constraint is not met (e.g., if the parameter structure index is not within the parameter structure index valid range), the electronic device 102 may generate 606 a first indication. This may be accomplished as described above in connection with one or more of FIGS. 1-2. The first indication may correspond to the first bitstream constraint. For example, the first indication may indicate that at least one parameter structure has an associated parameter structure index that is outside of the parameter structure index valid range. In some configurations, the electronic device 102 may utilize the first indication to do one or more of modify the bitstream 110 (such that no parameter structure index is outside of the parameter structure index valid range, for example), modify encoding procedures and indicate bitstream 110 (e.g., encoder 106) non-conformance.

If the bitstream constraint is met, the electronic device 102 may return to obtaining 602 a subsequent message structure. For example, if the parameter structure index is within the parameter structure index valid range, the electronic device 102 may return to obtaining 602 a subsequent message structure. In some configurations, the electronic device 102 may indicate that the parameter structure index was within the parameter structure index valid range.

Alternatively, if the bitstream constraint is met, the electronic device 102 may determine 608 whether an additional bitstream constraint is met. For example, assuming that the electronic device 102 has determined 604 that the first bitstream constraint is met, the electronic device 102 may determine 608 whether the second bitstream constraint, the third bitstream constraint, the fourth bitstream constraint, the fifth bitstream constraint or the sixth bitstream constraint is met.

If the additional bitstream constraint is not met, the electronic device 102 may generate 610 a corresponding indication. For example, the electronic device 102 may generate an indication corresponding to the (e.g., first, second, third, fourth, fifth, sixth) bitstream constraint that was not met. This indication may indicate that the corresponding bitstream constraint was not met (e.g., that the bitstream 110 is non-conformant). In some configurations, the electronic device 102 may perform one or more actions based on the bitstream constraint that was not met (e.g., based on the corresponding indication) as described in connection with FIG. 1. For example, the electronic device 102 may utilize the indication to do one or more of modify the bitstream 110 (such that the corresponding bitstream constraint is met, for example), modify encoding procedures and indicate bitstream 110 (e.g., encoder 106) non-conformance.

In some configurations, the electronic device 102 may proceed to determine whether an additional bitstream constraint is met regardless of whether a preceding bitstream constraint is met. For example, if the electronic device 102 determines 604 that a bitstream constraint is not met, the electronic device 102 may optionally generate 606 a corresponding indication and may proceed to determine 608 whether an additional bitstream constraint is met.

As illustrated in FIG. 6, the method 600 may include determining whether one or more bitstream constraints are met. Additionally, the method 600 may include generating a corresponding indication for one or more of the bitstream constraints that are not met. For example, the method 600 may include determining whether one or more of the six bitstream constraints described in connection with FIG. 1 are met. The method 600 may optionally include generating corresponding indications for one or more of the six bitstream constraints that are not met. It should be noted that determining whether each of the bitstream constraints is met may be performed in any order. For example, the electronic device may determine 604 whether the second bitstream constraint is met first and then determine whether the first bitstream constraint is met in some configurations. It should also be noted that the method 600 may operate in accordance with one or more of the configurations, options and variants described above in connection with FIG. 1.

In one example, assume that the electronic device 102 first determines 604 that the first bitstream constraint is met as described above. In this example, the electronic device 102 may then proceed to determine 608 whether the second bitstream constraint is met. For example, the electronic device 102 may identify a delivery schedule valid range from the sub-layer HRD parameter structure. The electronic device 102 may determine 608 whether the delivery schedule index is within the delivery schedule valid range. The electronic device 102 may generate 610 a second indication if the delivery schedule index is not with the delivery schedule valid range. This may be accomplished as described above in connection with FIG. 1.

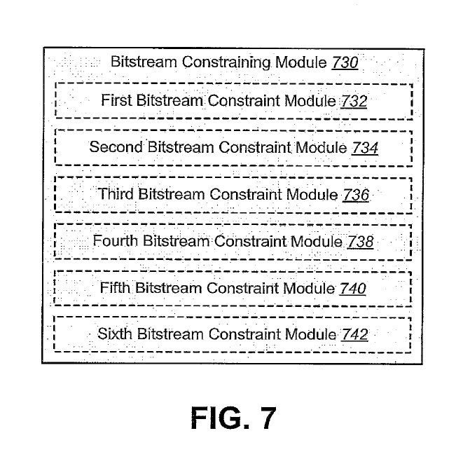

FIG. 7 is a block diagram illustrating examples of a bitstream constraining module 730. The bitstream constraining module 730 described in connection with FIG. 7 may be one example of the bitstream constraining modules 108a-b described in connection with FIG. 1.

The bitstream constraining module 730 may include one or more of a first bitstream constraint module 732, a second bitstream constraint module 734, a third bitstream constraint module 736, a fourth bitstream constraint module 738, a fifth bitstream constraint module 740 and a sixth bitstream constraint module 742. Each of the bitstream constraint modules 732, 734, 736, 738, 740, 742 may ensure that their respective bitstream constraint is met as described in connection with one or more of FIGS. 1-6. Each of the bitstream constraint modules 732, 734, 736, 738, 740, 742 may be implemented in hardware (e.g., circuitry) or a combination of hardware and software (e.g., a processor with instructions). As described in connection with FIG. 1, the bitstream constraining module 730 may be included in an encoder, a decoder, both an encoder and a decoder or neither. For example, the bitstream constraining module 730 may be implemented on an electronic device for determining whether a received bitstream is conformant or not.

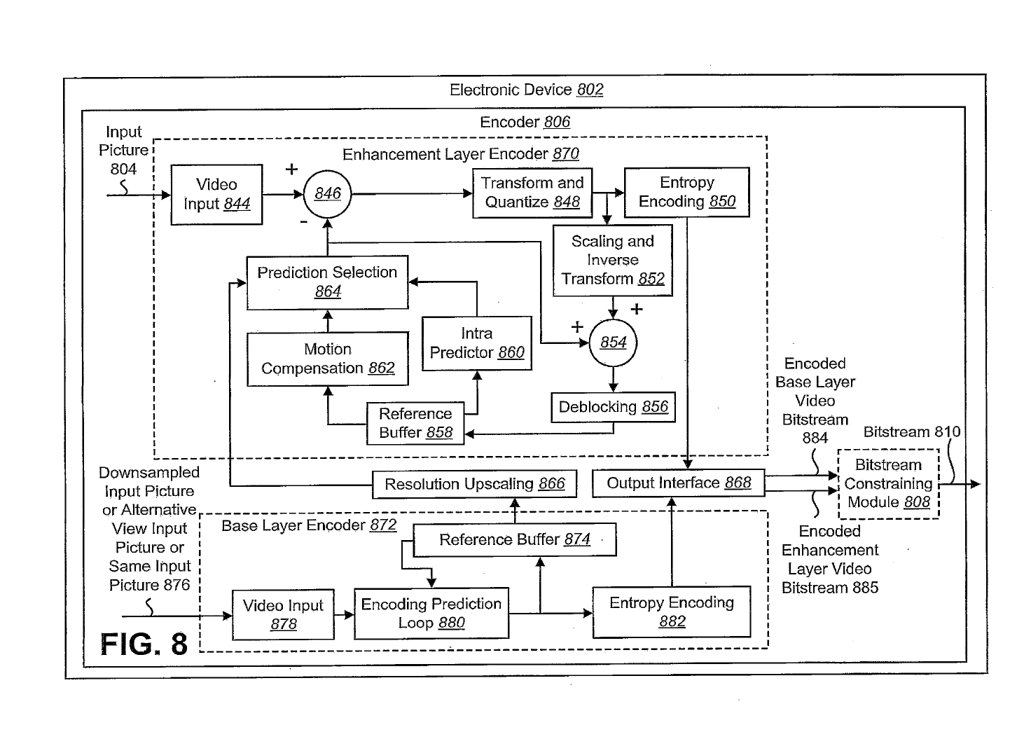

FIG. 8 is a block diagram illustrating one configuration of a encoder 806 on an electronic device 802. The encoder 806 of FIG. 8 may be one example of the encoder 106 described in connection with FIG. 1. The encoder 806 may include an enhancement layer encoder 870, a base layer encoder 872, a resolution upscaling block 866 and an output interface 868.

The enhancement layer encoder 870 may include a video input 844 that receives an input picture 804. The output of the video input 844 may be provided to an adder/subtractor 846 that receives an output of a prediction selection 864. The output of the adder/subtractor 846 may be provided to a transform and quantize block 848. The output of the transform and quantize block 848 may be provided to an entropy encoding block 850 and a scaling and inverse transform block 852. After entropy encoding 850 is performed, the output of the entropy encoding block 850 may be provided to the output interface 868. The output interface 868 may output both the encoded base layer video bitstream 884 and the encoded enhancement layer video bitstream 885.

The output of the scaling and inverse transform block 852 may be provided to an adder 854. The adder 854 may also receive the output of the prediction selection 864. The output of the adder 854 may be provided to a deblocking block 856. The output of the deblocking block 856 may be provided to a reference buffer 858. An output of the reference buffer 858 may be provided to a motion compensation block 862. The output of the motion compensation block 862 may be provided to the prediction selection 864. An output of the reference buffer 858 may also be provided to an intra predictor 860. The output of the intra predictor 860 may be provided to the prediction selection 864. The prediction selection 864 may also receive an output of the resolution upscaling block 866.

The base layer encoder 872 may include a video input 878 that receives a downsampled input picture or an alternative view input picture or the same input picture 876 (i.e., the same as the input picture 804 received by the enhancement layer encoder 870). The output of the video input 878 may be provided to an encoding prediction loop 880. Entropy encoding 882 may be provided on the output of the encoding prediction loop 880. The output of the encoding prediction loop 880 may also be provided to a reference buffer 874. The reference buffer 874 may provide feedback to the encoding prediction loop 880. The output of the reference buffer 874 may also be provided to the resolution upscaling block 866. Once entropy encoding 882 has been performed, the output may be provided to the output interface 868.

In some configurations, one or more of the encoded based layer video bitstream 884 and the encoded enhancement layer video bitstream 885 may be provided to an optional bitstream constraining module 808. The bitstream constraining module 808 described in connection with FIG. 8 may be an example of one or more of bitstream constraining module A 108a described in connection with FIG. 1 and the bitstream constraining module 730 described in connection with FIG. 7. The bitstream constraining module 808 may constrain one or more of the encoded based layer video bitstream 884 and the encoded enhancement layer video bitstream 885 in accordance with one or more of the bitstream constraints as described above in connection with one or more of FIGS. 1-7. In configurations where the bitstream constraining module 808 modifies one or more of the encoded based layer video bitstream 884 and the encoded enhancement layer video bitstream 885, the output bitstream 810 may be a modified version of one or more of the encoded based layer video bitstream 884 and the encoded enhancement layer video bitstream 885. In configurations where the bitstream constraining module 808 does not modify the encoded based layer video bitstream 884 or the encoded enhancement layer video bitstream 885, the bitstream 810 may include one or more of the (unmodified) encoded based layer video bitstream 884 and the (unmodified) encoded enhancement layer video bitstream 885.

In some configurations, the bitstream constraining module 808 may generate one or more indications. Each of the one or more indications may indicate bitstream non-conformance. Additionally or alternatively, each of the one or more indications (e.g., first indication, second indication, third indication, fourth indication, fifth indication, sixth indication) may indicate that a corresponding bitstream constraint is not met. The one or more indications may be provided to one or more of the encoder 806, the electronic device 802 and a remote electronic device (e.g., an electronic device 102b including a decoder).

In some configurations, the bitstream 810 may be transmitted to another electronic device (e.g., electronic device 102b). For example, bitstream B 810b may be provided to a communication interface, network interface, wireless transmitter, port, etc. For instance, bitstream B 810b may be transmitted to another electronic device via a local area network (LAN), the Internet, a cellular phone base station, etc. The bitstream 810 may additionally or alternatively be stored in memory or other component on the electronic device 802.

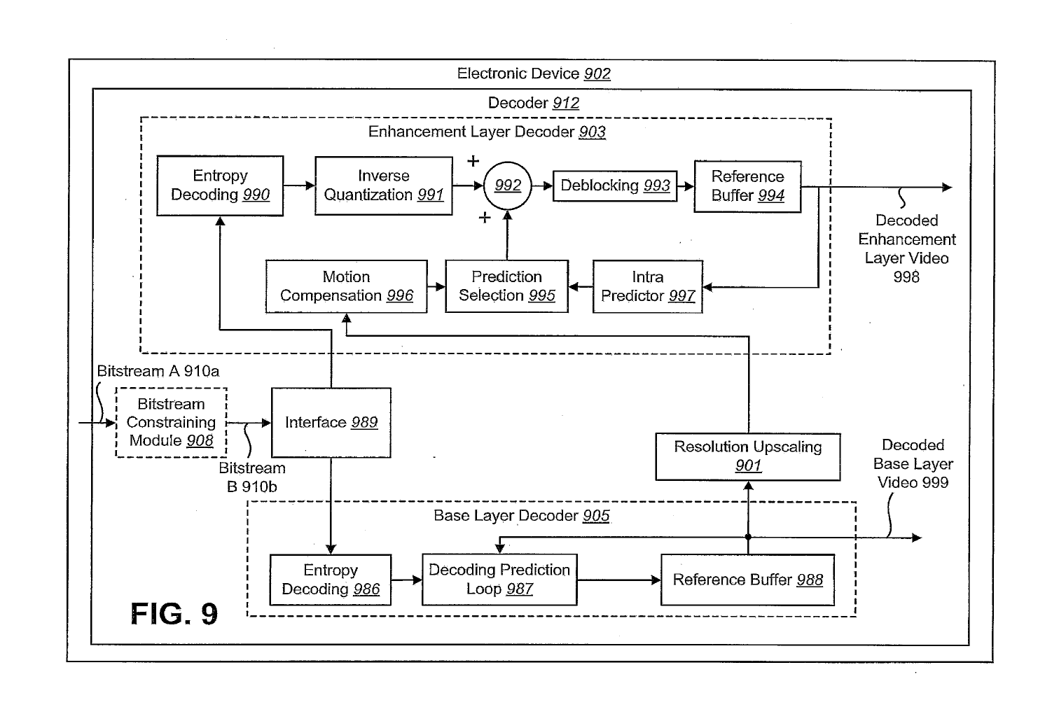

FIG. 9 is a block diagram illustrating one configuration of a decoder 912 on an electronic device 902. The decoder 912 of FIG. 9 may be one example of the decoder 112 described in connection with FIG. 1. The decoder 912 may include an enhancement layer decoder 903 and a base layer decoder 905. The decoder 912 may also include an interface 989 and resolution upscaling 901.

The decoder 912 may optionally include a bitstream constraining module 908. In some configurations, the electronic device 902 receives bitstream A 910a and provides bitstream A 910a to the bitstream constraining module 908.

The bitstream constraining module 908 described in connection with FIG. 9 may be an example of one or more of bitstream constraining module B 108b described in connection with FIG. 1 and the bitstream constraining module 730 described in connection with FIG. 7. The bitstream constraining module 908 may constrain bitstream A 910a in accordance with one or more of the bitstream constraints as described above in connection with one or more of FIGS. 1-8. In configurations where the bitstream constraining module 908 modifies bitstream A 910a, the bitstream constraining module 908 may provide bitstream B 910b as a modified version of bitstream A 910a. In configurations where the bitstream constraining module 908 does not modify bitstream A 910a, bitstream B 910b may be the same as bitstream A 910a.

In some configurations, the bitstream constraining module 908 may generate one or more indications. Each of the one or more indications may indicate bitstream non-conformance. Additionally or alternatively, each of the one or more indications (e.g., first indication, second indication, third indication, fourth indication, fifth indication, sixth indication) may indicate that a corresponding bitstream constraint is not met. The one or more indications may be provided to one or more of the decoder 912, the electronic device 902 and a remote electronic device. It should be noted that the bitstream constraining module 908 may be part of a decoder 912 or another component on the electronic device 902.

The interface 989 may receive bitstream B 910b. Bitstream B 910b may include one or more of a base layer encoded video stream and an enhancement layer encoded video stream. The base layer encoded video stream and the enhancement layer encoded video stream may be sent separately or together. The interface 989 may provide some or all of bitstream B 910b to an entropy decoding block 986 in the base layer decoder 905. The output of the entropy decoding block 986 may be provided to a decoding prediction loop 987. The output of the decoding prediction loop 987 may be provided to a reference buffer 988. The reference buffer 988 may provide feedback to the decoding prediction loop 987. The reference buffer 988 may also output the decoded base layer video 999.

The interface 989 may also provide some or all of bitstream B 910b to an entropy decoding block 990 in the enhancement layer decoder 903. The output of the entropy decoding block 990 may be provided to an inverse quantization block 991. The output of the inverse quantization block 991 may be provided to an adder 992. The adder 992 may add the output of the inverse quantization block 991 and the output of a prediction selection block 995. The output of the adder 992 may be provided to a deblocking block 993. The output of the deblocking block 993 may be provided to a reference buffer 994. The reference buffer 994 may output the decoded enhancement layer video 998.

The output of the reference buffer 994 may also be provided to an intra predictor 997. The enhancement layer decoder 903 may include motion compensation 996. The motion compensation 996 may be performed after the resolution upscaling 901. The prediction selection block 995 may receive the output of the intra predictor 997 and the output of the motion compensation 996.

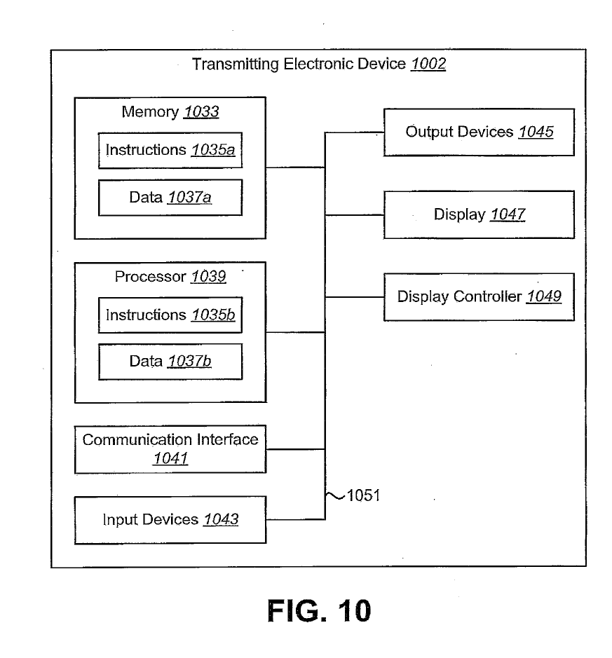

FIG. 10 illustrates various components that may be utilized in an electronic device 1002. The electronic device 1002 illustrated in FIG. 10 may be implemented in accordance with one or more of the electronic devices 102a-b, 802, 902, 1102 and 1202 described herein.

The electronic device 1002 includes a processor 1039 that controls operation of the electronic device 1002. The processor 1039 may also be referred to as a central processing unit (CPU). Memory 1033, which may include both read-only memory (ROM), random access memory (RAM) or any type of device that may store information, provides instructions 1035a (e.g., executable instructions) and data 1037a to the processor 1039. A portion of the memory 1033 may also include non-volatile random access memory (NVRAM). The memory 1033 may be in electronic communication with the processor 1039.

Instructions 1035b and data 1037b may also reside in the processor 1039. Instructions 1035b and/or data 1037b loaded into the processor 1039 may also include instructions 1035a and/or data 1037a from memory 1033 that were loaded for execution or processing by the processor 1039. The instructions 1035b may be executed by the processor 1039 to implement one or more of the methods 200, 600 disclosed herein.

The electronic device 1002 may include one or more communication interfaces 1041 for communicating with other electronic devices (e.g., receiving electronic device). The communication interfaces 1041 may be based on wired communication technology, wireless communication technology, or both. Examples of a communication interface 1041 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a wireless transceiver in accordance with 3^{rd} Generation Partnership Project (3GPP) specifications and so forth.

The electronic device 1002 may include one or more output devices 1045 and one or more input devices 1043. Examples of output devices 1045 include a speaker, printer, etc. One type of output device that may be included in a electronic device 1002 is a display device 1047. Display devices 1047 used with configurations disclosed herein may utilize any suitable image projection technology, such as a cathode ray tube (CRT), liquid crystal display (LCD), light-emitting diode (LED), gas plasma, electroluminescence or the like. A display controller 1049 may be provided for converting data stored in the memory 1033 into text, graphics, and/or moving images (as appropriate) shown on the display 1047. Examples of input devices 1043 include a keyboard, mouse, microphone, remote control device, button, joystick, trackball, touchpad, touchscreen, lightpen, etc.

The various components of the electronic device 1002 are coupled together by a bus system 1051, which may include a power bus, a control signal bus and a status signal bus, in addition to a data bus. However, for the sake of clarity, the various buses are illustrated in FIG. 10 as the bus system 1051. The electronic device 1002, illustrated in FIG. 10, is a functional block diagram rather than a listing of specific components.

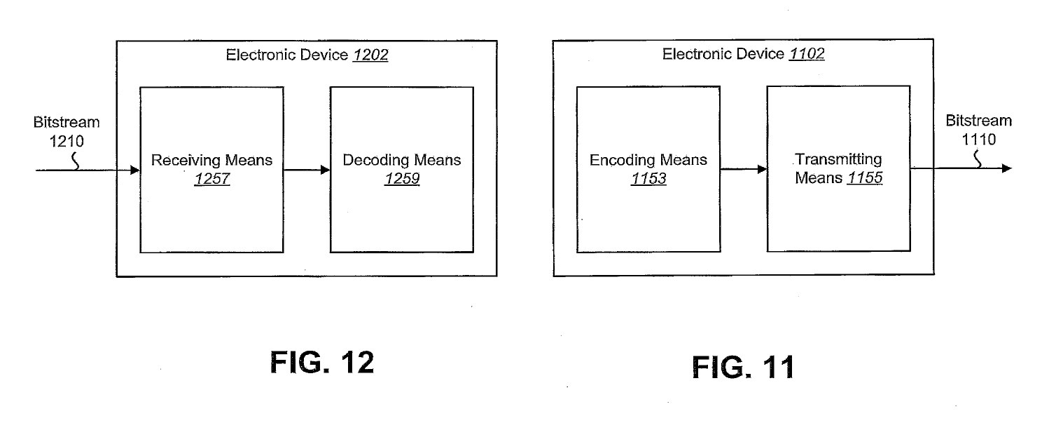

FIG. 11 is a block diagram illustrating one configuration of an electronic device 1102 in which systems and methods for constraining a bitstream may be implemented. The electronic device 1102 may include encoding means 1153 and transmitting means 1155. The electronic device 1102 may generate a bitstream 1110. The encoding means 1153 and transmitting means 1155 may be configured to perform one or more functions described in connection with one or more of FIGS. 1-8 described herein. FIG. 10 illustrates one example of a concrete apparatus structure of FIG. 11. Other various structures may be implemented to realize one or more of the functions of FIGS. 1-8. For example, one or more of the functions of FIGS. 1-8 may be realized by a processor.

FIG. 12 is a block diagram illustrating another configuration of an electronic device 1202 in which systems and methods for constraining a bitstream may be implemented. The electronic device 1202 may include receiving means 1257 and decoding means 1259. The electronic device 1202 may receive a bitstream 1210. The receiving means 1257 and decoding means 1259 may be configured to perform one or more of the functions described in connection with one or more of FIGS. 1-7 and 9 described herein. FIG. 10 above illustrates one example of a concrete apparatus structure of FIG. 12. Other various structures may be implemented to realize one or more functions of FIGS. 1-7 and 9. For example, one or more functions of FIGS. 1-7 and 9 may be realized by a processor.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray (registered trademark) disc where disks usually reproduce data magnetically, while discs reproduce data optically with lasers.

It should be noted that one or more of the methods described herein may be implemented in and/or performed using hardware. For example, one or more of the methods or approaches described herein may be implemented in and/or realized using a chipset, an ASIC, a LSI or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for constraining a bitstream by an electronic device, comprising:
obtaining a message structure, wherein the message structure comprises a parameter structure corresponding to a bitstream partition;
obtaining a parameter structure index referring to the parameter structure;
determining whether the parameter structure index is within a parameter structure index valid range; and
generating a first indication if the parameter structure index is not within the parameter structure index valid range.

2. The method of claim 1, wherein the message structure is a Video Parameter Set (VPS) Video Usability Information (VUI) message structure or a bitstream partition Hypothetical Reference Decoder (HRD) parameters Supplemental Enhancement Information (SEI) message structure.

3. The method of claim 1, wherein the message structure further comprises a delivery schedule index and a sub-layer Hypothetical Reference Decoder (HRD) parameter structure, wherein the method further comprises:
identifying a delivery schedule valid range from the sub-layer HRD parameter structure;
determining whether the delivery schedule index is within the delivery schedule valid range; and
generating a second indication if the delivery schedule index is not within the delivery schedule valid range.

4. The method of claim 1, wherein if only one bitstream partition is signaled for a layer set in the message structure, the bitstream partition does not exactly match the layer set.

5. The method of claim 1, wherein if only one bitstream partition is signaled for a layer set in the message structure, the bitstream partition is allowed to match the layer set if no parameters in the message structure are signaled for the layer set or if parameters specific to the bitstream partition match any parameters signaled in a Video Parameter Set (VPS) for the layer set.

6. The method of claim 1, wherein the parameter structure index is coded using a fixed length coding scheme.

7. The method of claim 1, wherein any layer in a layer set is not included in more than one bitstream partition.

8. The method of claim 1, wherein each bitstream partition of a layer set is distinct from any other bitstream partition of the layer set.

9. An electronic device for constraining a bitstream, comprising:
a processor;
memory in electronic communication with the processor, wherein instructions stored in the memory are executable to:
obtain a message structure, wherein the message structure comprises a parameter structure corresponding to a bitstream partition;
obtain a parameter structure index referring to the parameter structure;
determine whether the parameter structure index is within a parameter structure index valid range; and
generate a first indication if the parameter structure index is not within the parameter structure index valid range.

10. The electronic device of claim 9, wherein the message structure is a Video Parameter Set (VPS) Video Usability Information (VUI) message structure or a bitstream partition Hypothetical Reference Decoder (HRD) parameters Supplemental Enhancement Information (SEI) message structure.

11. The electronic device of claim 9, wherein the message structure further comprises a delivery schedule index and a sub-layer Hypothetical Reference Decoder (HRD) parameter structure, wherein the instructions are further executable to:
identify a delivery schedule valid range from the sub-layer HRD parameter structure;
determine whether the delivery schedule index is within the delivery schedule valid range; and
generate a second indication if the delivery schedule index is not within the delivery schedule valid range.

12. The electronic device of claim 9, wherein if only one bitstream partition is signaled for a layer set in the message structure, the bitstream partition does not exactly match the layer set.

13. The electronic device of claim 9, wherein if only one bitstream partition is signaled for a layer set in the message structure, the bitstream partition is allowed to match the layer set if no parameters in the message structure are signaled for the layer set or if parameters specific to the bitstream partition match any parameters signaled in a Video Parameter Set (VPS) for the layer set.

14. The electronic device of claim 9, wherein the parameter structure index is coded using a fixed length coding scheme.

15. The electronic device of claim 9, wherein any layer in a layer set is not included in more than one bitstream partition.

16. The electronic device of claim 9, wherein each bitstream partition of a layer set is distinct from any other bitstream partition of the layer set.

17. A non-transitory, tangible computer-readable medium for constraining a bitstream, comprising executable instructions for:
obtaining a message structure, wherein the message structure comprises a parameter structure corresponding to a bitstream partition;
obtaining a parameter structure index referring to the parameter structure;
determining whether the parameter structure index is within a parameter structure index valid range; and
generating a first indication if the parameter structure index is not within the parameter structure index valid range.

18. The computer-readable medium of claim 17, wherein the message structure is a Video Parameter Set (VPS) Video Usability Information (VUI) message structure or a bitstream partition Hypothetical Reference Decoder (HRD) parameters Supplemental Enhancement Information (SEI) message structure.

19. The computer-readable medium of claim 17, wherein the message structure further comprises a delivery schedule index and a sub-layer Hypothetical Reference Decoder (HRD) parameter structure, wherein the computer-readable medium further comprises executable instructions for:
identifying a delivery schedule valid range from the sub-layer HRD parameter structure;
determining whether the delivery schedule index is within the delivery schedule valid range; and
generating a second indication if the delivery schedule index is not within the delivery schedule valid range.

20. The computer-readable medium of claim 17, wherein if only one bitstream partition is signaled for a layer set in the message structure, the bitstream partition does not exactly match the layer set.
